(19) United States
(12) Patent Application Publication
(10) Pub. No.: US 2025/0155642 A1
(43) Pub. Date: May 15, 2025

(54) FIBRE EXIT ELEMENT

(71) Applicant: FIBERBRIDGE PHOTONICS GMBH, Hannover (DE)

(72) Inventor: Thomas THEEG, Seelze (DE)

(21) Appl. No.: 18/729,702

(22) PCT Filed: Jan. 18, 2023
(86) PCT No.: PCT/EP2023/051068

§ 371 Date: Jul. 17, 2024

(30) Foreign Application Priority Data
Jan. 27, 2022 (DE) 10 2022 101 915.2

(51) Int. Cl. G02B 6/26; G02B 6/32; G02B 6/34; G02B 6/36

(52) U.S. Cl. CPC G02B 6/262; G02B 6/32; G02B 6/34; G02B 6/3636; G02B 6/3672

(57) ABSTRACT

The invention relates to a fiber exit element (1, 2, 3) comprising: a plurality of glass fibers (1) each having at least one core (10), each of which is designed to guide a signal light beam (A); and at least one optical element (2) which is connected in each case to an open end of the cores (10) of the glass fibers (1) at an entry surface (21) and is designed to receive the signal light beam (A) from the open ends of the cores (10) of the glass fibers (1) and emit same outwards in the form of exit beams via at least one exit surface (22), characterized by at least one first housing (30) which is connected to the optical element (2) and, together with the optical element (2), forms a first housing space (C) which at least substantially, preferably completely, encloses at least the entry surface (21) of the optical element (2) with the open ends of the cores (10) of the glass fibers (1), wherein the first housing (30) has a first housing shell (30a) which extends at least substantially, preferably exactly, parallel to the glass fibers (1) and is designed to be optically transparent and/or optically absorbent at least in sections, and wherein the first housing (30) has a fiber feedthrough element (30b) through which the glass fibers (1) extend, preferably vertically, in a loosely guided or fixedly connected manner, and at least sections of which are designed to be optically reflective and/or optically absorbent.

The present invention relates to a fiber exit element according to claim 1.

Nowadays, glass fibers are used in many different technical fields. The technical and particularly high-technical applications include the use of glass fibers for light transmission. Thus, glass fibers are used for data transmission by means of light; in this case, the glass fibers can also be referred to as optical waveguides or passive optical fibers. Glass fibers are also used in medicine for example for illumination and for producing images, for example in microscopes, in inspection cameras and in endoscopes. Furthermore, glass fibers are used in sensors which can then be referred to as fiber-optic sensors.

A further field of application for glass fibers is laser technology. Here, the laser radiation can be guided as a signal light beam by means of a passive glass fiber from a laser radiation source as a signal light source or as a signal light beam source to a processing point in order to carry out there, for example in material processing or in medicine, for example, cutting or welding. The laser beam can also be fed to a sample as laser radiation in this way, for example in measurement technology, microscopy or spectroscopy. The use of passive glass fibers for guiding a laser beam can take place, for example, in applications such as mechanical engineering, telecommunications, medical technology and sensor technology.

Glass fibers can also be used to generate or amplify laser light and are referred to as active glass fibers. Fiber lasers for generating laser light or fiber amplifiers for amplifying laser light have, in sections, a doped fiber core (see below), which forms the active medium of the fiber laser or of the fiber amplifier, i.e. its active glass fiber. Common doping elements of the laser-active fiber core are in particular neodymium, ytterbium, erbium, thulium and holmium. Fiber lasers or fiber amplifiers are used, inter alia, in the industry for ultrashort pulse laser systems (for example at a wavelength of about 1 μm), in measurement technology (for example for LIDAR measurements-laser detection and ranging), in medical applications (for example at a wavelength of about 2 μm) or in space applications (for example at a wavelength of about 1.5 μm).

Glass fibers, which are used to amplify signal light such as laser radiation in fiber amplifiers or to generate laser radiation in fiber lasers, usually have a fiber core, which consists of pure glass such as pure quartz glass and, in the case of passive glass fibers, is often doped with germanium; in the case of active glass fibers, doping is usually carried out as described above. In certain cases, the fiber cladding can also be doped; this applies to both passive and active glass fibers. Depending on the size and the numerical aperture of the fiber core, it is possible to distinguish between single-mode and multi-mode glass fibers. In addition, the fiber core can still have polarization-maintaining properties for the light and can therefore be referred to as polarization-maintaining optical fibers (PM). They can also be photonic crystal glass fibers and hollow-core glass fibers. Even if the main field of application relates to glass fibers, polymer fibers or fibers made of other materials, for example so-called soft glass fibers for the mid IR range, can likewise be used for such applications.

The fiber core is usually surrounded radially from the outside by at least one fiber cladding, which is usually closed in the circumferential direction and thus completely surrounds the fiber core, apart from the two open ends of the glass fiber. The fiber cladding is also usually made of quartz glass.

Usually, both passive glass fibers and active glass fibers are surrounded by a fiber coating made of polymer, for example, comparable to the fiber cladding, which can then be attributed to the glass fiber. The fiber coating can serve to mechanically protect the glass interior of the glass fiber and influence the optical properties thereof. In the case of glass fibers in which the light is guided exclusively in the fiber core (single-clad glass fibers), the fiber coating is usually primarily used for mechanical protection. Glass fibers which guide light in the fiber core and in the fiber cladding (double-clad glass fibers) are usually designed with a fiber coating for fulfilling mechanical and optical properties.

Two cross-sectional shapes that occur frequently in practice for the fiber cladding are cylindrical and octagonal. The octagonal shape for the fiber cladding is used in particular in the case of active glass fibers.

Such glass fibers can be produced in large lengths and are usually available as roll products. The diameter of the fiber cladding usually varies between approximately 80 μm and approximately 1 mm. The larger fiber diameters in particular are often referred to in practice as rod-type fibers.

Four essential passive fiber components are typically required for a fiber amplifier: a signal light beam input as an interface for feeding in or coupling the signal light beam to be amplified as input radiation from outside the fiber amplifier, a pump light coupler which transports the pump light beam from the pump light source into the cladding of the active glass fiber with virtually no loss, a pump light trap which receives unabsorbed pump light from the active glass fiber or removes it from the cladding of the glass fiber, and a signal light beam output which forms and/or guides the output radiation and thereby couples it out and makes it available outside the fiber amplifier. The signal light beam output can also be referred to as a fiber exit element or as fiber exit optics.

In the case of a fiber laser, a pump light coupler, an active glass fiber, a pump light trap and a signal light beam output are also usually used. Since here no signal light beam is supplied from outside, but the laser radiation is generated inside the fiber resonator between two reflectors or mirror elements, the signal light beam input is not required.

In any case, an optical window with a one-sided anti-reflection coating for the corresponding wavelengths or a lens for collimating the output radiation can serve as the signal light beam output or as a fiber exit element. The fiber exit optics can also be a further glass fiber which guides the output radiation to a destination. Such fiber exit optics are usually material bonded to the open end of the glass fiber, for example by welding, also known as splicing. This allows the signal light or the laser light to pass directly into the fiber exit optics, for example as an optical window or as a lens, and from there to the outside of the fiber amplifier or fiber laser, for example. The optical window or lens can be used to widen the beam of the signal light or laser light, i.e. increase its cross section and thus reduce its power density, which may be favorable or necessary for certain applications.

It is therefore known to material bond a single glass fiber to a single fiber exit element as described above. However, for many applications, for example in material processing or medical technology, it is relevant to use a plurality of laser beams in a spatially as compact as possible and, above all, thermally and mechanically highly stable arrangement at the point of use. This could be achieved, for example, in free-beam optics with any arrangement of microlenses, but this would result in the loss of the considerable advantages of fiber optic technology.

If instead a plurality of glass fibers each with a single fiber exit element are combined with one another, this leads to an additional effort in order to arrange and align the fiber exit elements with respect to one another, so that the respective signal light beams can emerge to one another and be used as desired. This at the same time represents a significant source of error during assembly, which can lead to a poor or even unusable end product. This also increases the installation space of the end product, at least in the region of the fiber exit elements. Furthermore, certain minimum distances of the individual glass fibers from one another cannot be avoided, which are due to the size of the respective fiber exit elements which are arranged parallel to one another and together form the actual fiber exit element.

WO 2020/254661 A1 describes a fiber exit element comprising a plurality of glass fibers, each having at least one core, each of which is designed to guide a signal light beam, and at least one optical element which is connected in each case to an open end of the cores of the optical fibers and is designed to receive the signal light beam from the open ends of the cores of the glass fibers and emit same outwards in the form of exit beams via at least one exit surface. The open ends of the cores of the glass fibers are each arranged within the material of the optical element with a depth of penetration, wherein at least the material of the open ends of the cores of the glass fibers is fused to the material of the optical element.

A disadvantage of fiber exit elements in general with only one glass fiber and in particular with the fiber exit element of WO 2020/254661 A1 with a plurality of glass fibers is that absorption losses of the signal light beam can occur during the propagation of the signal light beam within the optical element, since the material of the optical element is usually not completely transparent and thus at least a small amount of the signal light beam is absorbed as it passes through the optical element. The absorption leads to a heating of the material of the optical element, which is generally undesirable, as its optical properties can change, in particular with increasing or high heating of the optical element.

If the fiber exit element or its optical element has a plurality of glass fibers, as in the fiber exit element of WO 2020/254661 A1, the degree of heating is usually increased by the absorption losses of a plurality of signal light beams. This may be the case in particular if optical powers of several hundred watts or several kilowatts are transported per signal light beam or if wavelengths are used which can in principle cause comparatively high absorption losses in the material of the optical element.

It should also be noted that the heating is particularly strong where a plurality of cores of the glass fibers are arranged close to one another on or in the optical element and thus their signal light beams run close to one another. As a result, a particularly strongly heated area can form there, which is usually located well away from the edge of the optical element and thus only slowly emits its heat to the surroundings via the side surfaces of the optical element.

In this case, a heating gradient can also form from the particularly heated area to the side surfaces of the optical element, which can influence the propagation of the signal light beams. Such an inhomogeneous heat distribution in the optical element can also be caused or amplified by different optical powers of the signal light beam in the glass fibers of the optical element. In any case, high heating of the optical element due to the absorption losses of the signal light beam of a plurality of glass fibers can lead to a disturbance of the propagation or the propagation direction of the signal light beams. This can therefore lead to corresponding disruptions in the function of the fiber exit element even at temperatures which cannot yet cause damage or destruction of the fiber exit element.

With regard to the optical properties of the signal light beam, for example, inhomogeneous heating of the optical element caused by absorbed signal light beams can also lead to a temporal and spatial change in the refractive index in the material of the optical element and thus to a change in the wave fronts of the signal light beams, which can have a detrimental effect on the application in practice. For example, a thermal lens can form.

In any case, it should be noted that materials such as glass or quartz glass, which are usually used as the material of the optical element of fiber exit elements, are comparatively poor heat conductors and thus the heating due to the absorption losses of the signal light beam usually remains where it occurs, i.e. in the area of propagation of the signal light beams. Heat transport through the material of the optical element of the fiber exit element therefore usually occurs so slowly that there is a highly uneven distribution of heating in the material of the optical element. Rather, a gradient can form from the location where the heating occurs to the edge areas of the optical element, which can lead to the corresponding disadvantages as described above.

It should also be noted that quartz glass for optical applications is available in various quality grades, e.g. with regard to glass purity or OH content (hydroxide content). Depending on the wavelength of the signal light beam and the optical quality of the quartz glass, the absorption in the material can be reduced to a few ppm (parts per million) for material thicknesses of a few millimeters. In particular in the case of high optical power and a plurality of glass fibers per optical element, such as the fiber exit element of WO 2020/254661 A1, even low absorption in the material of the optical element can lead to heating in the optical element that is disruptive for the application. For single fibers, the heating of the optical element is typically still negligible.

Irrespective of this, it should also be noted that some of the signal light beams can also be thrown back into the optical element at the exit surface of the optical element, possibly at its optical coating or anti-reflection coating. Thus, this thrown back or reflected signal light beams, which can be referred to as interference beams, can also lead to absorption losses as described above and increase the degree of heating caused thereby. This also applies to signal light beams scattered within the optical element, which are referred to as scattered beams and can also be classified as interference beams. Furthermore, at the connection or splice point of the core of a glass fiber with the optical element, signal light beams can be deflected or decoupled from the path of the signal light beam and remain within the optical element as loss beams of the splice connection, so that these beams can also be attributed to the interference beams. Furthermore, beams from outside can also enter the optical element as interference beams.

U.S. Pat. No. 5,619,602 A describes an optical fiber cable for transmitting high-power laser light, comprising a fiber having a core and a cladding surrounding it, wherein at least one of the contact ends of the core is provided with a rod having a larger diameter than the core. The fiber is provided at this end with a reflector which is arranged within the optical fiber cable at a location which is located along the optical fiber at a distance from the rod and which is designed to guide beams propagating outside the fiber to an area where they can be absorbed without causing damage. The rod is substantially cylindrical in shape so that beams not coupled into the fiber are guided to the reflector. The absorbing reflector is arranged to direct the beams outside the fiber into an area surrounded by a heat-dissipating device with cooling fins.

U.S. Pat. No. 6,167,177 A describes an optical fiber cable comprising a fiber having a central core and a surrounding cladding, wherein the fiber cable is intended for transmitting optical high-power, specifically power exceeding 1 KW. At least the end portion of the fiber that is to receive the high-power optical radiation is placed in a cooling chamber with a front wall that has a transparent window. The end face of the optical fiber is arranged in optical contact with the window. The chamber is supplied with a flowing radiation-absorbing coolant which surrounds the outer surface of the fiber end portions in such a way that optical radiation incident outside the fiber enters the coolant and is at least partially absorbed by it, while the walls of the chamber are cooled directly by the flowing coolant to prevent any uncontrolled heating of the walls by the absorbed radiation. In one embodiment, the fiber is surrounded by a capillary tube made of a transparent material, e.g. quartz glass, so that the lateral surface of the capillary tube is in contact with the coolant.

A disadvantage of the previously known options for cooling or dissipating heat from fiber exit elements or their optical elements is that they are only known and can only be used for individual glass fibers, i.e. for fiber exit elements or their optical elements with only a single glass fiber. Also, the heat-dissipating device with cooling fins of U.S. Pat. No. 5,619,602 A and the flowing coolant of U.S. Pat. No. 6,167,177 A only have a heat-dissipating effect on the fiber exit element or its optical element from the outside and can therefore only insufficiently reach the source of heating within the optical element, in particular with glass as its material, if a plurality of signal light beams lead to absorption losses, as in the case of the fiber exit element of WO 2020/254661 A1. In other words, the heat dissipation measures of U.S. Pat. Nos. 5,619,602 A and 6,167,177 A do not reach the point where the absorption losses of the fiber exit element of WO 2020/254661 A1 occur.

Another disadvantage is that the use of a flowing coolant can require a comparatively high level of effort. In particular, a corresponding installation space is required for the fiber exit element itself as well as for the coolant lines and the cooling unit which carries out the conveying and cooling of the coolant. An electrical supply for the cooling unit is also usually required, which presupposes the possibility of an electrical supply and also requires an electrical cable for this purpose.

In any case, it should also be noted that such a fiber exit element can additionally or alternatively be heated by other external circumstances, framework conditions or environmental conditions, which can be just as disruptive as described above.

An object of the present invention is to provide a fiber exit element of the type described at the beginning, so that the heating of the optical element of the fiber exit element can be reduced. Additionally or alternatively, the handling of such a fiber exit element is to be improved. In particular, thermally induced mechanical forces at the connections between the glass fibers and the optical element are to be reduced. This is to be achieved in particular for the fiber exit element of WO 2020/254661 A1. The fiber exit element is to be as simple, cost-effective and/or space-saving as possible. At the very least, an alternative to known fiber exit elements is to be created.

The object is achieved according to the invention by a fiber exit element with the features of claim 1. Advantageous further developments are described in the subclaims.

Thus, the present invention relates to a fiber exit element comprising a plurality of glass fibers each having at least one core, each of which is designed to guide a signal light beam, and at least one optical element, preferably an optical window, an optical lens, an optical beam splitter or an optical prism, which is connected at an entry surface to an open end of each of the cores of the glass fibers, preferably further to an open end of a cladding of the glass fibers substantially enclosing the core, and is designed to receive the signal light beam from the open ends of the cores of the glass fibers and to emit same outwards in the form of exit beams via at least one exit surface.

Preferably, the open ends of the cores of the glass fibers, preferably further the open ends of claddings of the glass fibers substantially enclosing the cores, are each arranged with a penetration depth, preferably opposite an entry surface of the optical element, within the material of the optical element and at least the material of the open ends of the cores of the glass fibers, preferably further the material of the open ends of the claddings of the glass fibers, is fused to the material of the optical element. Among other things, this can improve the mechanical connection between the glass fibers and the optical element.

The fiber exit element according to the invention is characterized by at least one first housing which is connected to the optical element and, together with the optical element, forms a first housing space which at least substantially, preferably completely, encloses the entry surface of the optical element with the open ends of the cores of the glass fibers, wherein the first housing has a first housing shell which extends at least substantially, preferably exactly, parallel to the glass fibers and is designed to be optically transparent and/or optically absorbent at least in sections, and wherein the first housing has a fiber feedthrough element through which the glass fibers extend, preferably vertically, in a loosely guided or fixedly connected manner, and at least sections of which are designed to be optically reflective and/or optically absorbent.

In other words, according to the invention, the optical element can be surrounded by the first housing at least on the side of its entry surface, on which the glass fibers are connected to the optical element, in such a way that at least interference beams emerging through the entry surface into the first housing space can reach the first housing as completely as possible. The first housing space can also be referred to as the housing interior. The first housing serves to keep this interference beams away from the optical element and thus prevents it from reaching the optical element again. This can prevent the interference beams from being absorbed by the optical element and thus contributing to heating of the optical element. In addition, the first housing can also serve to improve the handling of the fiber exit element, as will be described in more detail below.

In order to implement this in concrete terms, the housing shell of the first housing can be designed in terms of its material to absorb the interference beams and thereby convert them into heat, which the housing shell can then substantially emit into the first housing space as well as to the outside of the first housing both by means of thermal radiation and by means of convection. This also applies to the fiber feedthrough element of the first housing. The implementation can be carried out, for example, by means of a metallic or ceramic material, the surface of which facing the first housing space can preferably be matt, black or blackened. This can cause the first housing to heat up, which can also have a small effect on the optical element via heat conduction. Nevertheless, the interference beams can be kept away from the optical element in this way and thus its direct heating due to absorption losses can be avoided.

Alternatively, the housing shell of the first housing can also be transparent, which can be implemented, for example, using glass or quartz glass as the material. In this case, the interference beams can penetrate the housing shell of the first housing as completely as possible, thereby reaching the outside of the housing shell and thus being kept away from the optical element.

Alternatively, the fiber feedthrough element can also be designed to be reflective, which can be implemented, for example, by means of a polished or mirrored inner surface of the fiber feedthrough element. In this case, the interference beams can be reflected or thrown back from the inner surface of the fiber feedthrough element into the first housing space, so that these interference beams can then either be absorbed by the housing shell or pass through it as previously described. In any case, heating of the fiber feedthrough element by the interference beams can be avoided in this way.

In any case, designing the fiber feedthrough element in a non-transparent manner can be advantageous in that the interference beams can be kept away from the coatings of the glass fibers outside the first housing. This can prevent the interference beams from having a damaging effect on the usually polymeric material used to coat the glass fibers.

The present invention is based on the finding that the aspects of the invention described above can keep interference beams away from the optical element or its optical body and thus reduce the amount of heating that can occur there due to the absorption of interference beams. This can reduce the heating of the optical element or keep it sufficiently low in order to reduce or even completely avoid the negative effects described in the beginning. In particular, a comparatively low heating can occur more evenly than a comparatively high heating, so that in particular a gradient formation of the heating within the optical element can be avoided or at least reduced in this way.

In any case, the optical element can be circular, oval, quadrangular, rectangular, square, quadrangular and similar with regard to its cross-sectional area. The first housing shell and the fiber feedthrough element can be designed accordingly, for example cylindrical and circular. This may depend on the desired arrangement of the glass fibers or the application case.

The first housing can further serve to guide and/or connect or hold the glass fibers relative to the optical element in order to hold or stabilize the glass fibers and thereby enable or at least facilitate the handling, assembly, transport and similar of the fiber exit element. In other words, the fiber exit element can be grasped by a person directly or by means of aids on the first housing in order to be able to handle or transport the fiber exit element, but without touching the optical element or damaging or breaking the glass fibers at the welded joint. This can prevent damage and contamination of the optical element.

For this purpose, it may be sufficient to guide one or more glass fibers loosely, i.e. unconnected, through the corresponding through openings of the fiber feedthrough element, which can be done with radial contact or also without radial contact to the inner edge of the through openings of the fiber feedthrough element. This allows the first housing space to be substantially enclosed from the surroundings. The glass fibers could also be guided in the longitudinal direction and supported radially.

Additionally or alternatively, some or a plurality of glass fibers can be connected to the fiber feedthrough element, which can be achieved in a force-fit manner by matching the dimensions of the outside of the glass fibers to the inner sides of the through openings of the fiber feedthrough element. Alternatively or additionally, a material bond connection can be made, selectively, in sections or completely, between the outer sides of the glass fibers and the inner sides of the through openings and/or in front of and/or behind the through openings of the fiber feedthrough element, for example by bonding or by fusing. This allows the corresponding glass fibers to be fixed along their elongated extension on the fiber feedthrough element, whereby a mechanical relief (e.g. strain relief and bending protection of the glass fibers) of the connection between the glass fibers and the optical element can be realized. In this way, the corresponding glass fibers can also be indirectly connected to the fiber exit element in a fixed manner along their elongated extension, which can increase the mechanical stability of the glass fibers relative to the fiber exit element.

This can be implemented for one of the glass fibers, for a plurality of the glass fibers or for all of the glass fibers, which increases the design freedom and makes it possible to use or implement the respective properties and advantages described above.

In the case of a fixed connection of glass fibers to both the optical element and the fiber feedthrough element (e.g. by welding or bonding), it should be noted that if the first housing shell heats up to a certain extent, e.g. due to interference beams or external environmental influences, the first housing shell may expand in length, whereby the connections between glass fibers and the optical element and/or the fiber feedthrough element may be subjected to a possibly comparatively strong mechanical stress. As a result, the connections between glass fibers and the optical element can be damaged or even destroyed. Even small tensile forces can cause stress birefringence due to a length expansion of the first housing shell in the optical element, in particular in the region of the connection points to the open ends of the glass fibers. This can, for example, influence the polarization and other properties of the signal light beam. Especially in the case of a fixed connection of glass fibers and fiber exit element, it can therefore be advantageous to avoid heating of the first housing shell or to keep it as low as possible in order to avoid corresponding mechanical length expansions or to keep them as low as possible.

In any case, and in particular in the case where the first housing shell is designed to be optically absorbent, the first housing shell may preferably comprise or even consist of a material with a comparatively low thermal expansion, i.e. with a comparatively small change in the geometric dimensions of the first housing shell, in particular in its longitudinal extension direction, depending on its heating, such as quartz glass, aluminum, steel or technical ceramic. In this way, corresponding geometric changes and in particular length expansions with increasing heating of the first housing shell can be kept comparatively small or as small as possible. This can be particularly advantageous if glass fibers are also connected to the fiber feedthrough element and thus a thermally induced change in length of the first housing shell could exert a tensile stress on the corresponding glass fibers and in particular on the connection of the glass fibers to the optical element. This can be achieved, in particular in favor of the lowest possible optical absorption of the interference beams, by using quartz glass as the material of the first housing shell, which also has a comparatively low coefficient of expansion.

Furthermore, it must be taken into account that when the optical element is connected to the first housing shell, the heat generated or absorbed in the optical element can be transferred to the first housing shell by thermal conduction. In addition, the temperature of the first housing shell can vary due to external influences, e.g. environmental influences. Thus, the geometric expansion, in particular the length expansion, of the first housing shell can also be problematic, for example during transport or at times when any existing and necessary cooling, as described in more detail below, is not active for the fiber exit element with housing. Optionally, these problems can be prevented by the measures described above, since otherwise, as already described, the connections of the glass fibers and the optical element in particular could be damaged or even destroyed by increased mechanical stresses. In other words, the inner housing shell can withstand the temperature fluctuations that occur in practice, in particular with regard to its longitudinal expansion. For this purpose, a material with the same or similar coefficient of thermal expansion as the material of the glass fibers can preferably be used for the housing shell.

This may additionally or alternatively also apply to the fiber feedthrough element, i.e. the fiber feedthrough element may also preferably comprise a material with a comparatively low thermal expansion, preferably consisting thereof. Thus, the properties and advantages described above can additionally or alternatively be applied to the fiber feedthrough element.

According to one aspect of the invention, the first housing shell is designed to be completely optically transparent and the fiber feedthrough element is designed to be completely optically reflective. As a result, precisely this combination of the properties of the first housing shell and the fiber feedthrough element can be implemented and the corresponding advantages described above can be utilized.

According to a further aspect of the invention, the side of the fiber feedthrough element facing the housing space extends at least in sections, preferably completely, at an angle to the glass fibers. This can increase the freedom of design of the fiber exit element. In particular, the fiber feedthrough element may be exposed to increased interference beams if the glass fibers connected to the optical element emit signal light beams with a small NA (numerical aperture), as is the case with single-mode (SM) and large-mode area (LMA) glass fibers, for example. In particular, the angled arrangement of the sides of the fiber feedthrough element facing the housing space relative to the glass fibers, for example between 5° and 45°, can cause or facilitate a deflection of the interference beams to the side in order to allow as many interference beams as possible to be absorbed by the first housing shell or to pass through it. In this case, for example, the fiber feedthrough element can be designed to be wedge-shaped and the first housing shell can be designed to be rectangular.

According to a further aspect of the invention, the side of the fiber feedthrough element facing the housing space has at least two sections which extend at an angle to one another and/or to the glass fibers. This can increase the freedom of design of the fiber exit element. This can be an alternative way of implementing the properties described above. In particular, this allows the interference beams to be distributed more evenly over the first housing shell in order to heat it more evenly or to avoid uneven heating of the housing shell. In this case, for example, the fiber feedthrough element can be designed to be conical and the first housing shell can be designed to be cylindrical.

According to a further aspect of the invention, the side of the fiber feedthrough element facing the housing space extends at least in sections, preferably completely, curved towards the glass fibers. This can increase the freedom of design of the fiber exit element. This can be an alternative way of implementing the properties described above. In this case, for example, the fiber feedthrough element can be designed to be semicircular and the first housing shell can be designed to be cylindrical.

According to a further aspect of the invention, the first housing shell is designed optically roughened at least in sections, preferably completely, on the side facing the housing space and/or on the side facing away from the housing space. The implementation of an optically roughened or rough surface is described in more detail below. This allows the corresponding properties of the entry surface of the optical element to be implemented and used on one or both sides of the outer surface of the first housing shell.

According to a further aspect of the invention, at least the entry surface of the optical element, preferably all outer surfaces of the optical element, apart from the exit surface of the optical element, are designed optically roughened, and preferably at least the exit surface of the optical element, preferably precisely the exit surface of the optical element, is designed with an optically smooth surface quality. An optically roughened surface can be achieved, for example, by means of machining with a mechanical tool such as, for example, by grinding, but also by means of a laser beam as a tool. An optically smooth surface can also be achieved by means of machining with a mechanical tool such as, for example, by polishing, but also by means of a laser beam as a tool. An optically smooth surface quality is given if, at the corresponding wavelength or in the corresponding wavelength range of the signal light beam, the necessary optical properties can be largely obtained for the respective application when exiting via the exit surface or if a corresponding optical coating can be applied professionally. The scratch-dig specification of the MIL-PRF-13830B standard, among others, is often used to assess the surface quality.

An optically roughened surface of the optical element can be advantageous for its outer surfaces other than the exit surface in order to allow interference beams to exit from the optical element and thereby reduce them in the volume of the optical element and preferably to release them in a diffuse manner into the surroundings or into the first housing. Such interfering light can be cladding light from the cladding of the glass fibers. Reflection of the signal beams can also occur on the side surfaces of the optical element. In addition, signal light beams in the optical element can be partially reflected at the exit surface or at the anti-reflection coating of the optical element in the form of interfering light. Furthermore, signal light beams can be reflected back into the optical element from outside, for example from the processing or application site of the signal light beam and from downstream optics. As already mentioned, an optically roughened surface can be advantageous in order to reduce the aforementioned interfering light beams in the optical element and thus ensure a safe operating state.

According to a further aspect of the invention, the exit surface of the optical element has at least in sections, preferably over its entire surface, an optical coating, preferably an optical anti-reflection coating, and/or a plurality of microlenses, preferably one microlens per glass fiber and directly opposite the glass fiber. The microlenses can also have an anti-reflection coating.

In particular, an optical anti-reflection coating on the exit surface of the optical element can reduce or minimize the reflected signal light beams at the exit surface (glass-air interface). The anti-reflection coating can preferably be designed or optimized for the wavelengths or wavelength range of the signal light beam. This can reduce the amount of interference beams within the optical element or the surrounding first housing, and/or second housing, if any, see below. In this case, a minimal absorption of the signal light beam in a coating, preferably an anti-reflection coating, on the optical element can lead to a heating of the coating, which can be transferred via heat conduction to the optical element and possibly to the first housing.

The additional or alternative use or formation of microlenses, which together can also be referred to as a microlens array, can have a corresponding optical influence on the emitted signal light beam, e.g. the collimation of the signal light beams. Providing preferably one microlens per glass fiber and directly opposite the glass fiber can make it possible for the signal light beam of each glass fiber or its core to reach the respective microlens in a straight line through the optical element, so that the microlens can act on exactly the signal light beam of the glass fiber or its core assigned to it. The alignment of the microlens is thus carried out along the optical axis of the respective signal light beam.

According to a further aspect of the invention, the first housing and the optical element enclose the first housing space in a fluid-tight manner, wherein the first housing space is filled with fluid. The fluid can be a liquid or a gas. In any case, this can influence the propagation of the interference beams within the first housing space. In particular, the fluid can be selected in such a manner that within the first housing space the scattering behavior of the interference beams is enhanced and/or the absorption behavior of the interference beams and/or the heat conduction is adapted. Alternatively, protective gases or “dry” air can be filled into the first housing space, for example, in order to prevent the formation of condensation in applications with strong temperature fluctuations (e.g. aviation and space applications). This can be influenced by the choice of fluid and, in the case of a gas, also by the internal pressure within the first housing space.

According to a further aspect of the invention, the first housing space is at least in sections filled with material, preferably filled with a plurality of loose glass bodies. One material or a plurality of materials can be used together. The materials can preferably be optically transparent or reflective for the interference beams. This can be done in addition to or as an alternative to a fluid filling of the first housing space, since at least one material-free section of the first housing space can be filled with a fluid. This is especially true for the spaces between loose glass bodies, which can provide space for a fluid. However, the first housing space can also be completely filled with one material or with different materials together, so that in this case there can be no room for a fluid. In any case, the filling material, such as loose glass bodies, preferably in the form of glass microspheres or quartz glass spheres, can deflect interference beams and thus provide a more homogeneous distribution of the interference beams in all directions in the first housing interior. In the case of an optically reflective material, e.g. metal-coated microspheres, the spatial distribution of the interference beams in the inner housing can be achieved via multiple reflections of the interference beams.

The material and in particular the loose glass bodies such as glass microspheres or quartz glass spheres can also lie against the claddings of the glass fibers and act there as cladding light strippers, i.e. absorb signal light beams or interference beams or remaining pump light beams from a laser or amplifier system and thus protect the laser systems connected to the glass fibers and the beam paths downstream of the optical element from interfering light beams from the claddings of the glass fibers. Materials with the same or higher refractive index as the claddings of the glass fibers are suitable for cladding light strippers. The refractive index of the materials introduced can vary accordingly along the claddings of the glass fibers in order to extract the light as homogeneously as possible from the cladding of the fiber over a certain distance.

According to a further aspect of the invention, the fiber exit element further comprises at least one intermediate element which is arranged between the optical element and the fiber feedthrough element, preferably parallel to the fiber feedthrough element, wherein the glass fibers extend through the intermediate element, preferably vertically, loosely guided or fixedly connected, and wherein the intermediate element is at least in sections designed to be optically reflective, optically absorbent and/or designed as an optical diffuser. Thus, by means of the intermediate element, which can be designed in a manner comparable to the fiber feedthrough element, an additional element can be provided within the first housing or within the first housing space in order to additionally guide or hold the glass fibers as described above with regard to the fiber feedthrough element and/or to additionally reflect and/or absorb interference beams as described above with regard to the fiber feedthrough element. Furthermore, in the case of a diffuser, the interference beams can be distributed and thus reduced in intensity.

For all effects, it can be advantageous to arrange the intermediate element parallel to the fiber feedthrough element and/or the intermediate element approximately halfway between the optical element and the fiber feedthrough element. It can also be advantageous to arrange the intermediate element in the region of the glass fibers where the claddings of the glass fibers have no coating, so that the interference beams can be kept away from the coatings of the glass fibers, which, from the direction of the optical element, are arranged behind the intermediate element.

The fact that the intermediate element preferably comprises a material with a comparatively low thermal expansion, preferably consisting thereof, here can also bring the corresponding properties and advantages of the fiber feedthrough element described above to bear.

According to a further aspect of the invention, the first housing shell in sections, the optical element and the intermediate element together enclose a sub-region of the first housing space in a fluid-tight manner, wherein the sub-region of the first housing space is filled with fluid. This allows the corresponding aspects of the first housing space described above to be applied to the sub-region of the first housing space. At the same time, the costs can be kept correspondingly low due to the reduced volume of the sub-region compared to the entire first housing space.

According to a further aspect of the invention, the first housing shell in sections, the optical element and the intermediate element together enclose a sub-region of the first housing space, wherein the sub-region of the first housing space is filled with material at least in sections, preferably filled with a plurality of loose glass bodies. This allows the corresponding aspects of the first housing space described above to be applied to the sub-region of the first housing space. At the same time, the costs can be kept correspondingly low due to the reduced volume of the sub-region compared to the entire first housing space.

According to a further aspect of the invention, the fiber exit element further comprises at least one second housing, which is connected to the optical element and/or to the first housing and, together with the optical element and the first housing, forms a second housing space which encloses the optical element and the first housing at least substantially, preferably completely, except for the exit surface, wherein the second housing comprises a second housing shell which extends at least substantially, preferably exactly, parallel to the first housing shell and is designed to be optically absorbent at least in sections, preferably completely, wherein the second housing comprises an entry-side terminal element which extends at least substantially, preferably exactly, parallel to the first housing shell and is designed to be optically absorbent at least in sections, preferably completely, and/or wherein the second housing comprises an exit-side terminal element which extends at least substantially, preferably exactly, parallel to the optical element, preferably to its exit surface, and is designed to be optically absorbent at least in sections, preferably completely. The second housing space can also be referred to as the housing exterior space.

According to the invention, a second housing can be arranged at least substantially around the first housing in this way in order to further increase the possibilities of reducing the heating of the optical element. Accordingly, the first housing can also be referred to as the inner housing and the second housing as the outer housing. The first, inner housing and the second, outer housing can together also be referred to as the overall housing or the body of the fiber exit element. For example, in the case of a transparent first housing shell, the interference beams can be absorbed and thus received by the second, outer housing after they have passed through the transparent first housing shell. Due to the distance between the second, outer housing and the optical element, the interference beams absorbed there can be kept away from the optical element.

According to a further aspect of the invention, the second housing, the optical element and the first housing enclose the second housing space in a fluid-tight manner and the second housing, preferably the entry-side terminal element of the second housing, comprises a fluid inlet and a fluid outlet, so that a fluid can flow through the fluid inlet into the second housing space and can exit the second housing space again through the fluid outlet. In this way, it is possible to allow a fluid, such as in particular a cooling liquid, to flow through the second housing space in order to remove heat from both the first, inner housing and the second, outer housing with the fluid. In the case of a transparent first housing shell, interference beams can also enter the fluid directly, be absorbed there and thus their heat can be directly removed from the fluid. In any case, this can provide an active way of dissipating heat or cooling the optical element. Corresponding fluid lines such as hoses and fluid conveyors such as a pump can be provided outside the fiber exit element according to the invention and can be connected thereto.

According to a further aspect of the invention, the second housing, preferably the second housing shell, comprises at least one heat sink, preferably a plurality of cooling fins, facing away from the second housing space and/or protruding into the second housing space. In terms of its material, such a heat sink can be made of a material that exhibits a comparatively good thermal conductivity, so that heat is distributed as quickly or evenly as possible within the heat sink and can thus be released to the environment via the surface, which can result in appropriate cooling of the heat sink. Designing the heat sink in the form of cooling fins or providing it with cooling fins can significantly increase the surface area that can be in contact with the environment on the part of the heat sink. This can facilitate the release of heat to an ambient fluid such as air or ambient air outside the second, outer housing space and/or a cooling liquid inside the second, outer housing space. This can be provided alternatively or in combination.

According to a further aspect of the invention, outside the first housing space the optical element comprises preferably a heat sink, and inside the second housing space the optical element comprises at least one heat sink, preferably a plurality of cooling fins. This allows the corresponding aspects described above to be transferred to the optical element itself. Instead of cooling fins, for example, micro-channels or holes on the shell side can also be used. The heat sink of the optical element can be designed separately and arranged, preferably laterally, on the optical element. Preferably, the optical element or its optical body or its side surface can be designed as a plurality of cooling fins, so that the properties described above can be utilized here. At the same time, the costs can be kept comparatively low.

According to a further aspect of the invention, the optical element outside the first housing space preferably and inside the second housing space has a plurality of through-openings for the flow of a fluid and/or a plurality of through-openings, which are filled at least in sections, preferably completely, with a material with a comparatively good thermal conductivity. This can be achieved by means of through openings which are integrally surrounded by the material of the optical element and which can be introduced into the optical element, for example, by drilling, welding, etching and the like. The optical element can also comprise or consist of individual optical sub-elements, wherein the optical sub-elements can be arranged such that a fluid for cooling can flow between the optical sub-elements. For example, rectangular optical elements can be used in a stacked arrangement with certain distances between them.

In any case, such a fluid can be the ambient air, which can enable or simplify the implementation, in particular if only the first housing is used. If a fluid-filled second housing space is present, the fluid can not only flow around the optical element but also through its through openings, which can increase the heat dissipation from the optical element or its optical body to the fluid. The fluid can be, for example, the ambient air or a liquid. In particular, this allows the optical element or its optical body to be cooled in a comparatively even or as even as possible manner.

Alternatively or additionally, the through openings can also be filled with a material with a comparatively good thermal conductivity, such as copper, so that the heat can transfer from the material of the optical element to the filling material of the through openings and spread there more quickly in order to be conducted from the interior of the optical element to its edge region, which can facilitate the release of heat to the environment.

Preferably, the filling material can also protrude beyond the outer contour of the optical material, in particular in the form of ribs or the like, in order to increase the contact surface of the filling material with the fluid-filled environment and thereby improve the heat transfer to the fluid. The fluid can be, for example, the ambient air or another gas or even a liquid.

If the optical element is formed from optical sub-elements, as described above, the elements of the filling material can also serve as spacers for the optical sub-elements.

If the through openings are filled in sections with a material with a comparatively good thermal conductivity and in sections remain free of material and thus allow the fluid to flow through, the filling material can preferably be implemented at least in sections as a lining of the through openings in order to be in surface contact with the inner side or inner surface of the through opening and thereby facilitate heat transfer from the material of the optical element to the filling material. At the same time, in addition to heat conduction along the length of the filling material as described above, heat can be transferred to the fluid, which can further improve heat dissipation away from the optical element. In the case of cylindrical through openings, the implementation can be carried out, for example, by means of tubular elements of the filling material. In this case too, the surface area of the filling material can be increased in relation to the fluid, for example by means of ribs.

According to a further aspect of the invention, the exit surface of the optical element is larger than the entry surface of the optical element, wherein the optical element is preferably trapezoidal or conical in shape. This can increase the surface area over which heat can be dissipated from the optical element to the environment, which can also improve heat dissipation. Furthermore, such a trapezoidal design of the optical element can be adapted to the divergence of the signal light beam in order to bring the external cooling as close as possible to the heat sources. For this purpose, the optical element can have a trapezoidal cross section in the case of a square flat contour. If the optical element is circular, this can be implemented by means of a conical cross section.

According to a further aspect of the invention, at least one glass fiber, preferably a plurality of glass fibers, particularly preferably all glass fibers, has/have a coating, preferably of a polymer, which is arranged in sections in the first housing space, wherein the coating, at least within the first housing space, is enclosed at least in sections, preferably completely, by a non-transparent, preferably reflective and/or temperature-resistant material. This allows for coverage and thus protection against interference beams to be specifically achieved with regard to the coating of glass fibers.

Several exemplary embodiments and further advantages of the invention are illustrated and explained in more detail below, purely schematically, in connection with the following figures. In the drawings:

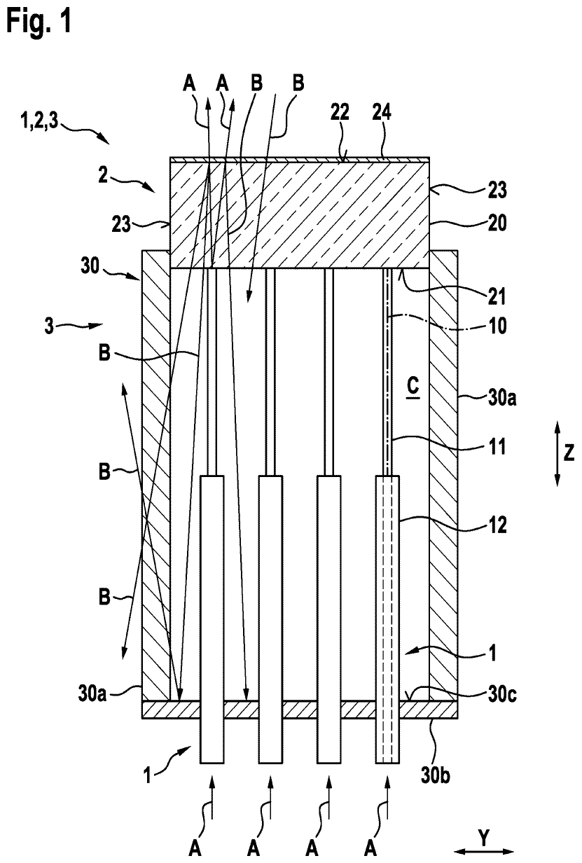

FIG. 1 shows a cross section of a fiber exit element according to the invention according to a first exemplary embodiment;

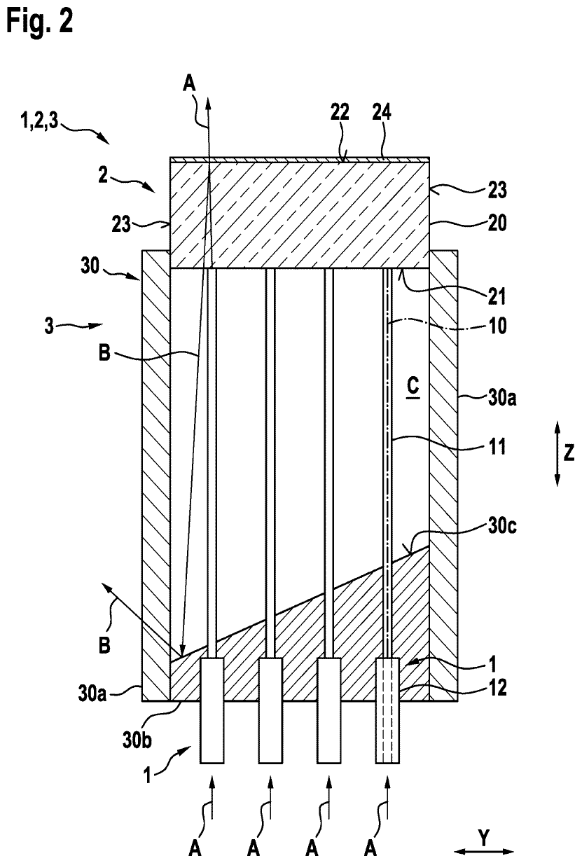

FIG. 2 shows a cross section of a fiber exit element according to the invention according to a second exemplary embodiment;

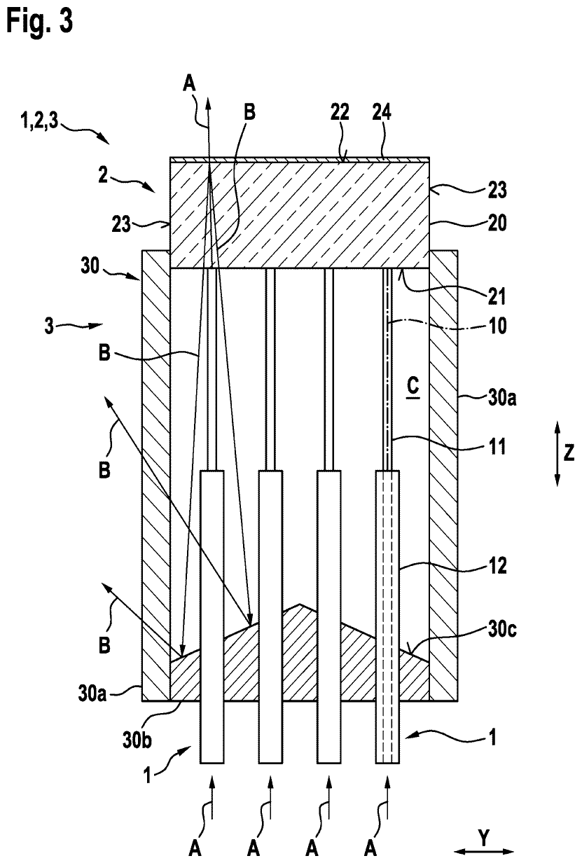

FIG. 3 shows a cross section of a fiber exit element according to the invention according to a third exemplary embodiment;

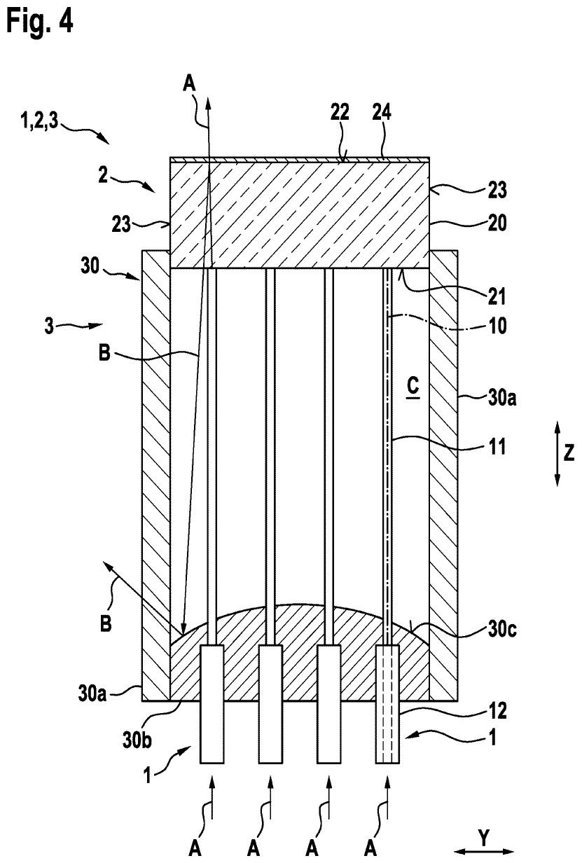

FIG. 4 shows a cross section of a fiber exit element according to the invention according to a fourth exemplary embodiment;

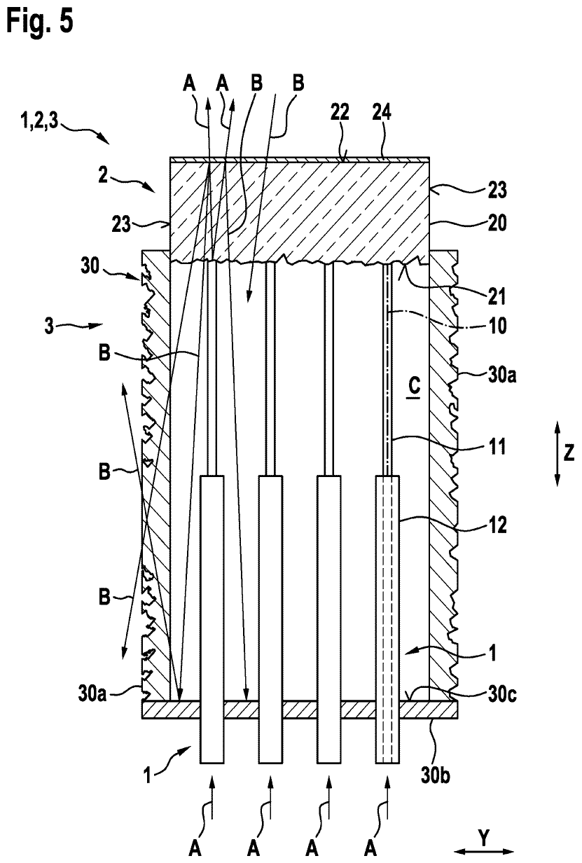

FIG. 5 shows a cross section of a fiber exit element according to the invention according to a fifth exemplary embodiment;

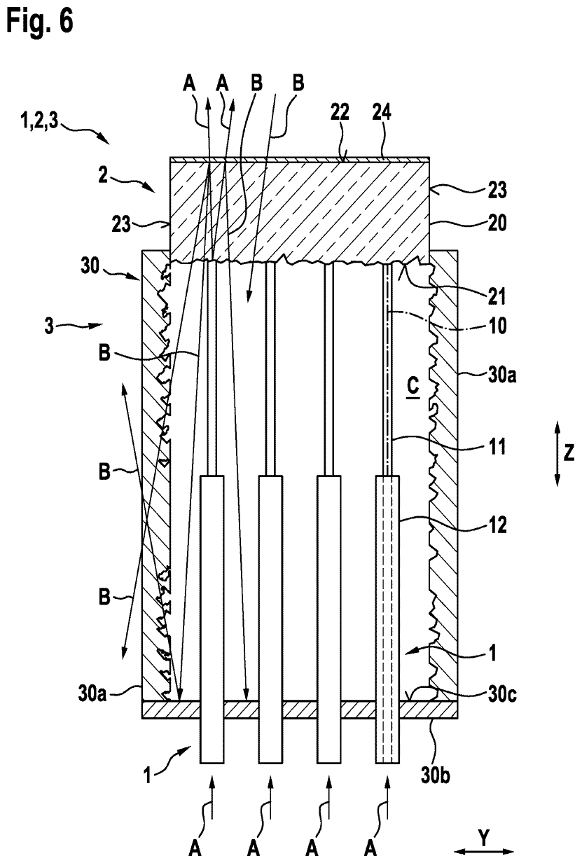

FIG. 6 shows a cross section of a fiber exit element according to the invention according to a sixth exemplary embodiment;

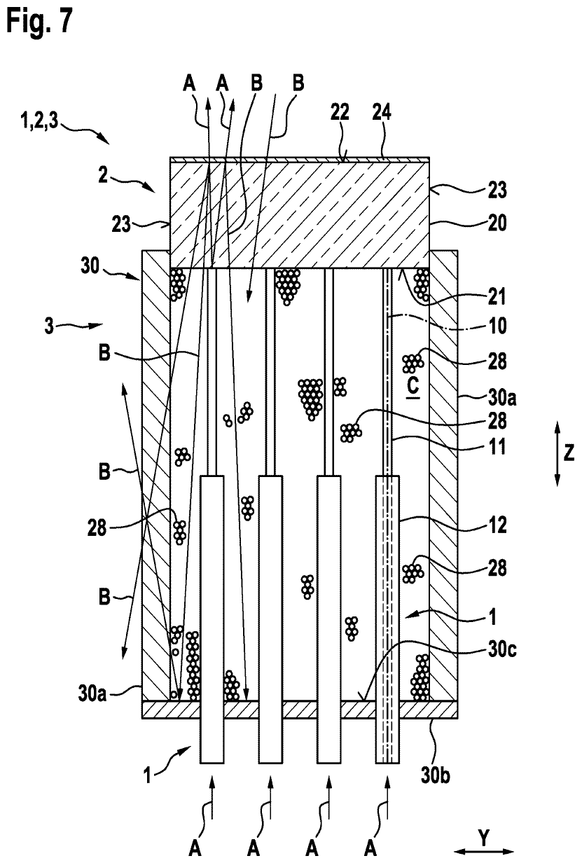

FIG. 7 shows a cross section of a fiber exit element according to the invention according to a seventh exemplary embodiment;

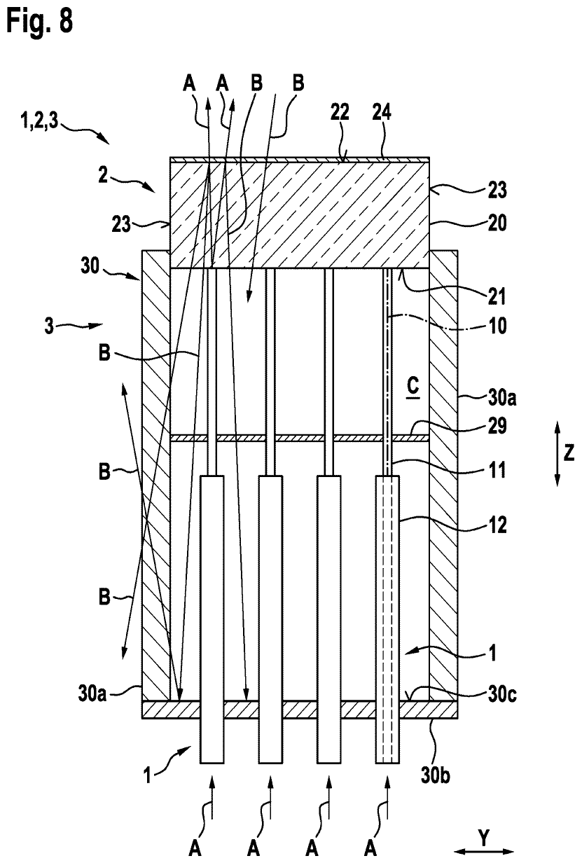

FIG. 8 shows a cross section of a fiber exit element according to the invention according to an eighth exemplary embodiment;

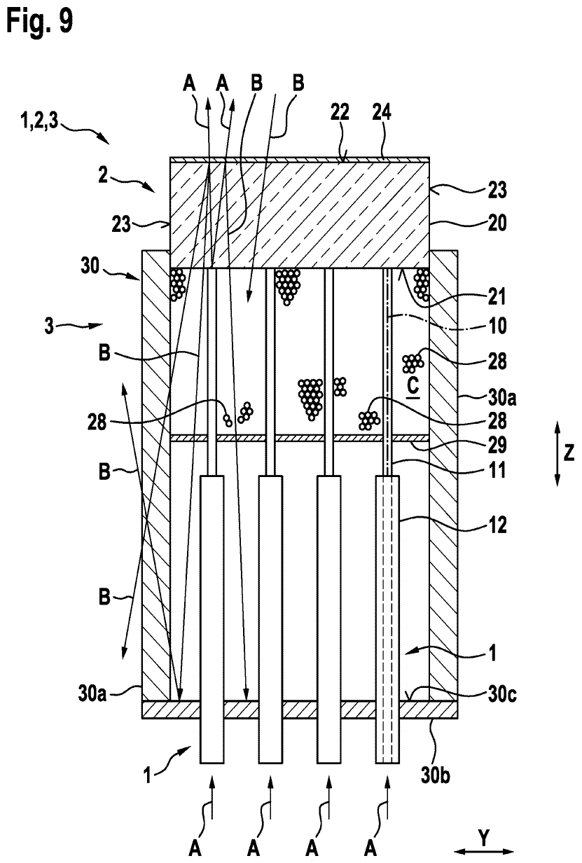

FIG. 9 shows a cross section of a fiber exit element according to the invention according to a ninth exemplary embodiment;

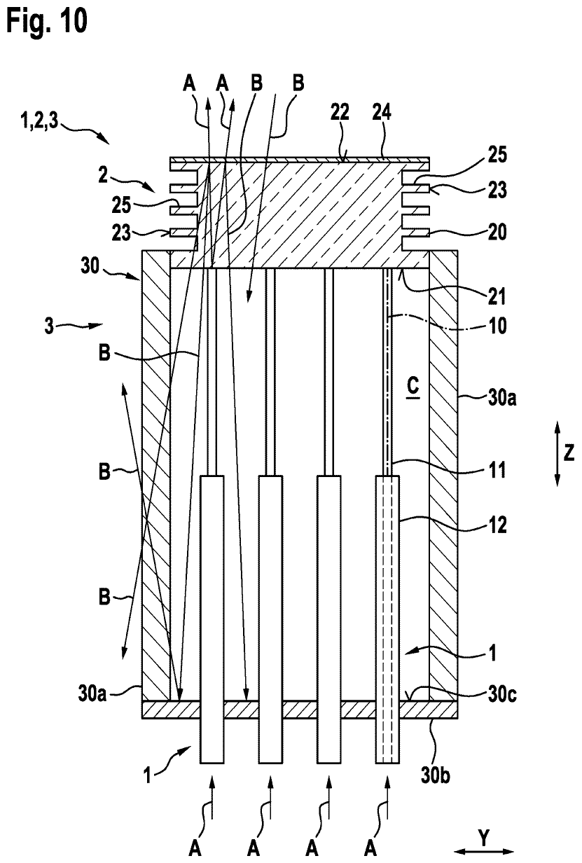

FIG. 10 shows a cross section of a fiber exit element according to the invention according to a tenth exemplary embodiment;

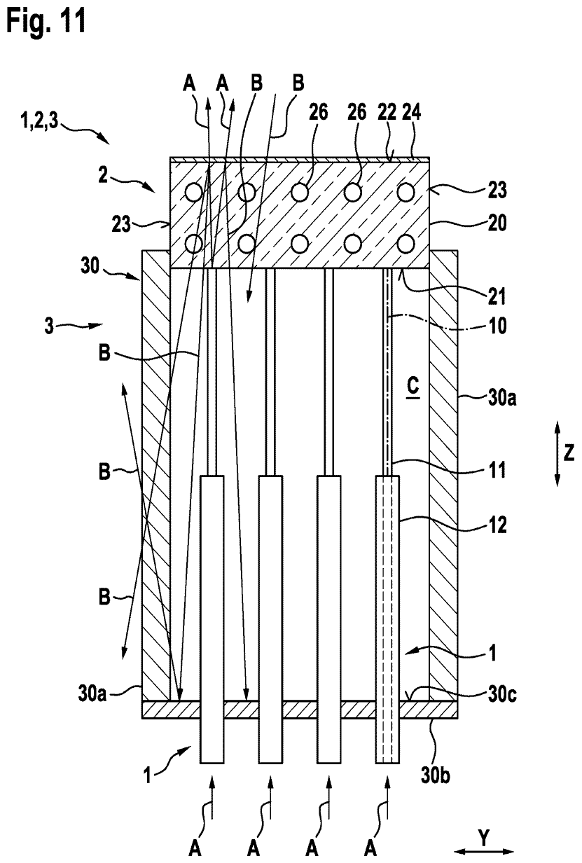

FIG. 11 shows a cross section of a fiber exit element according to the invention according to an eleventh exemplary embodiment;

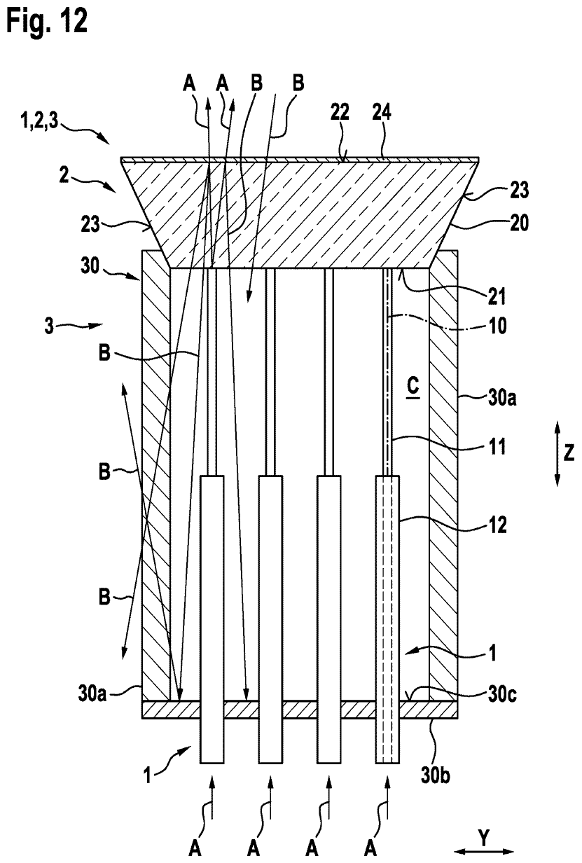

FIG. 12 shows a cross section of a fiber exit element according to the invention according to a twelfth exemplary embodiment;

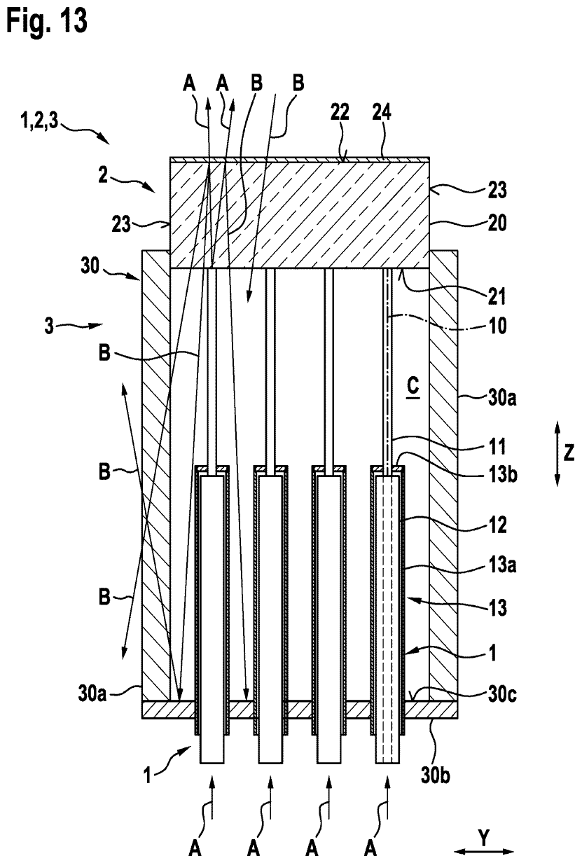

FIG. 13 shows a cross section of a fiber exit element according to the invention according to a thirteenth exemplary embodiment;

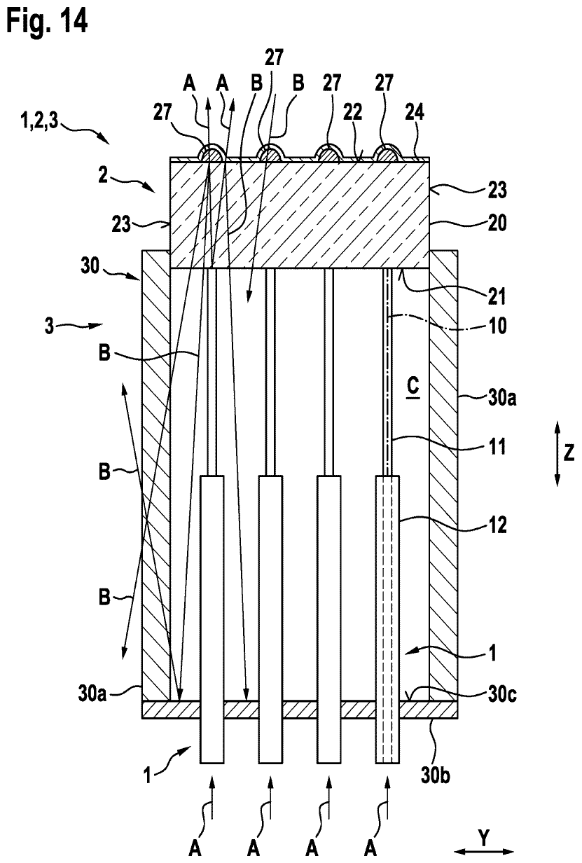

FIG. 14 shows a cross section of a fiber exit element according to the invention according to a fourteenth exemplary embodiment;

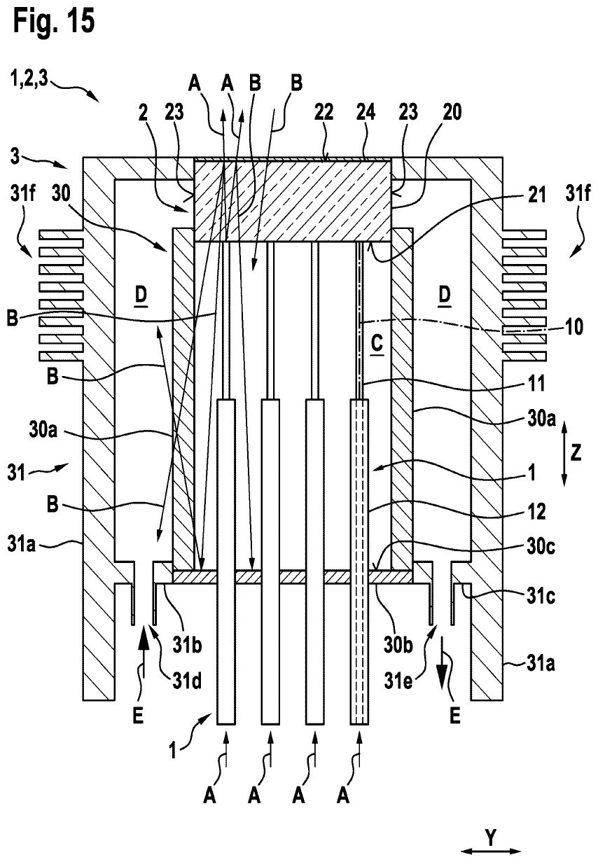

FIG. 15 shows a cross section of a fiber exit element according to the invention according to a fifteenth exemplary embodiment;

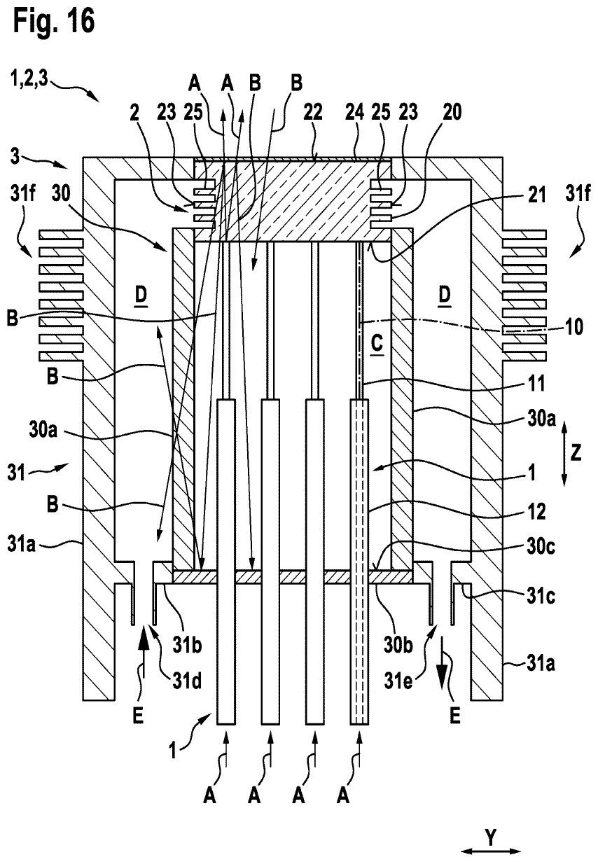

FIG. 16 shows a cross section of a fiber exit element according to the invention according to a sixteenth exemplary embodiment;

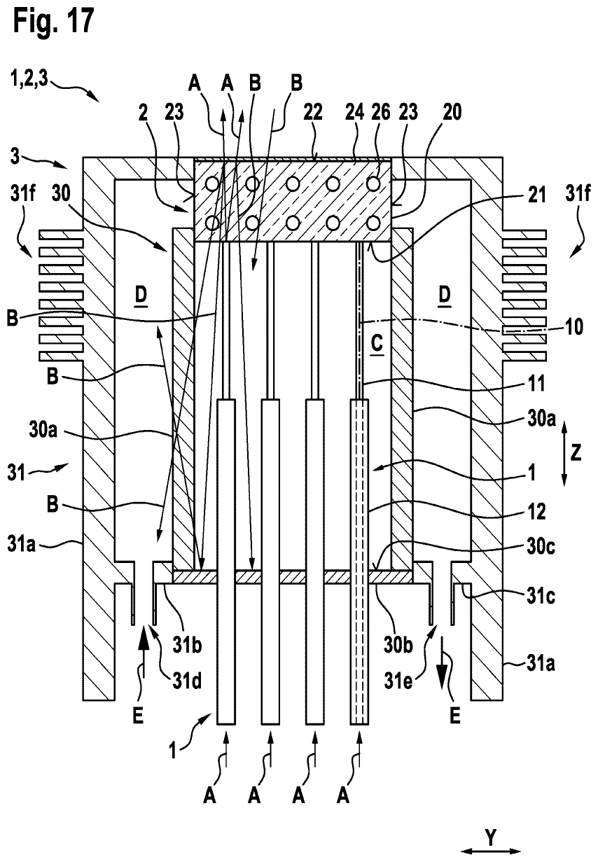

FIG. 17 shows a cross section of a fiber exit element according to the invention according to a seventeenth exemplary embodiment;

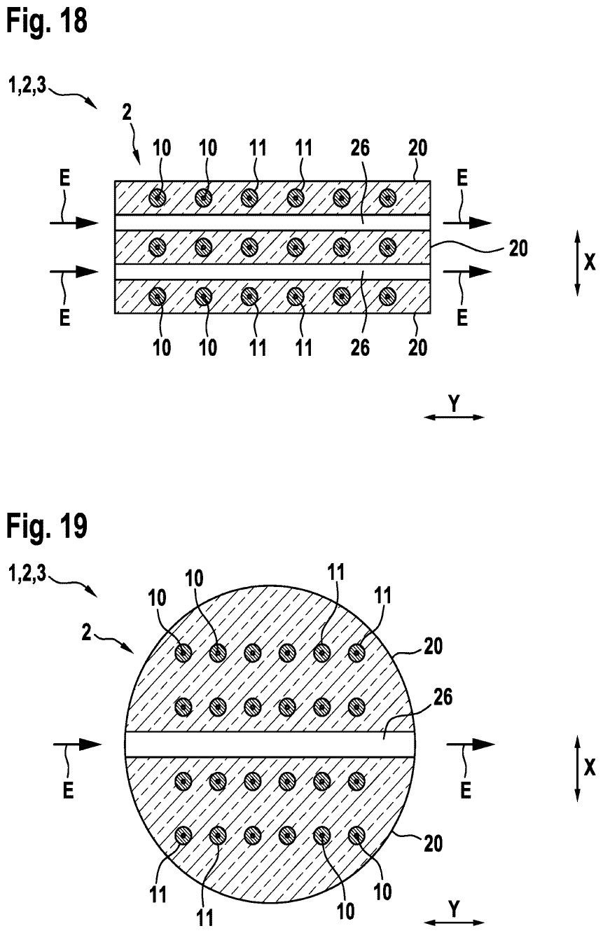

FIG. 18 shows a horizontal section in a detailed view of the fiber exit element according to the invention according to the seventeenth exemplary embodiment;

FIG. 19 shows an alternative to the representation of FIG. 18;

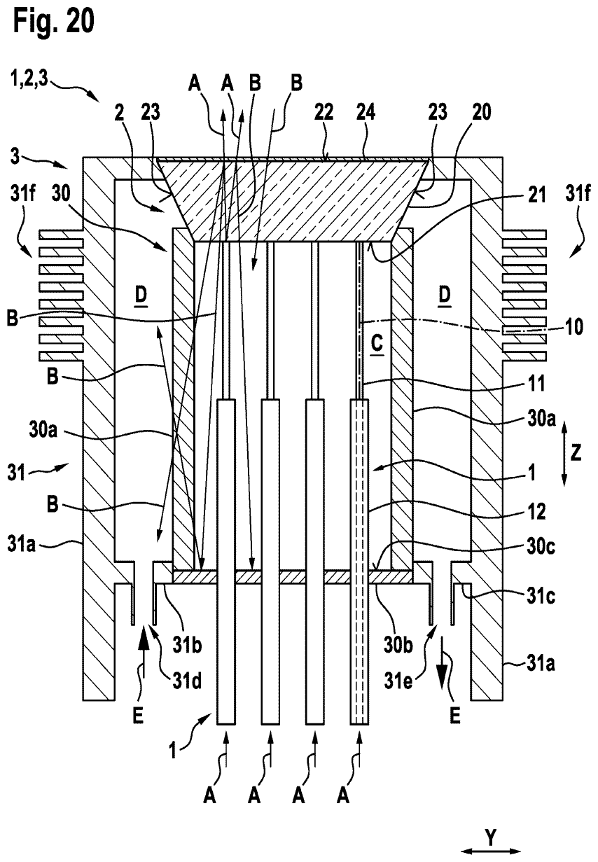

FIG. 20 shows a cross section of a fiber exit element according to the invention according to an eighteenth exemplary embodiment;

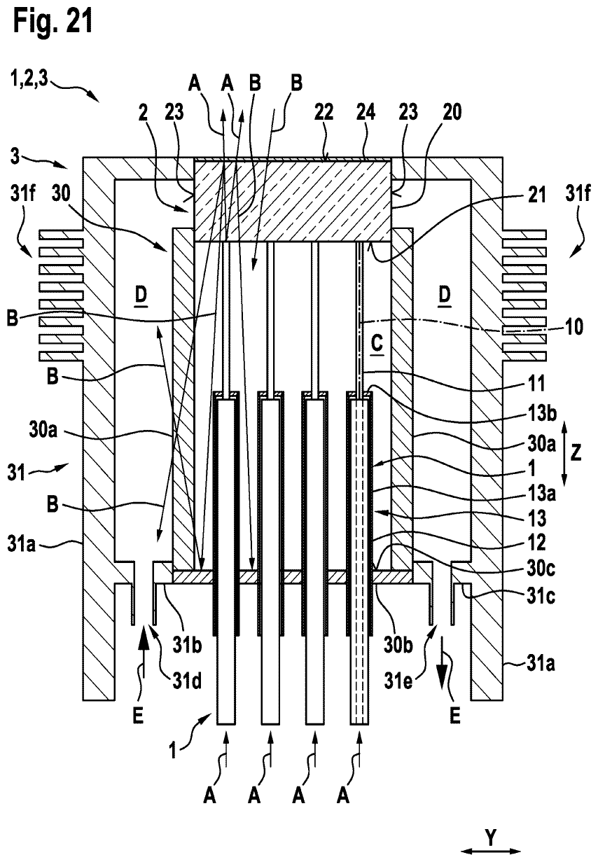

FIG. 21 shows a cross section of a fiber exit element according to the invention according to a nineteenth exemplary embodiment; and

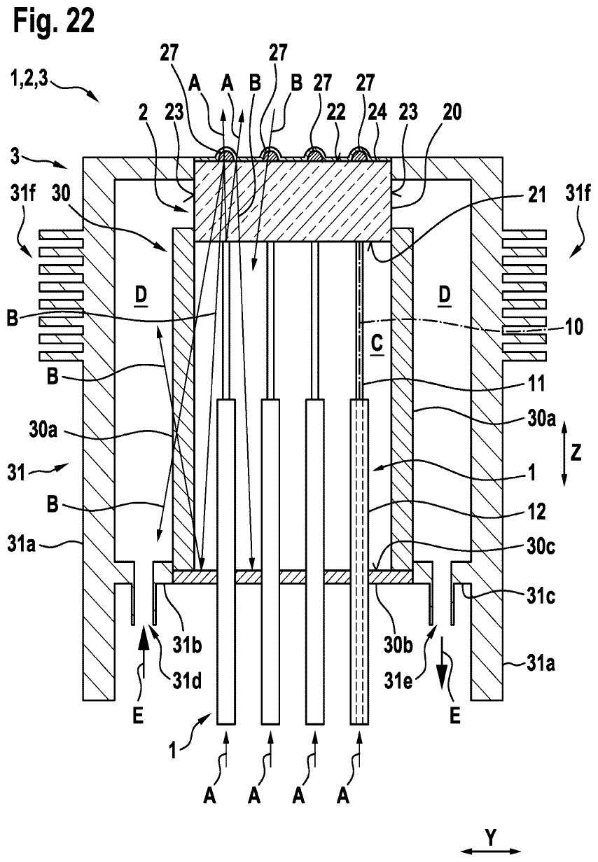

FIG. 22 shows a cross section of a fiber exit element according to the invention according to a twentieth exemplary embodiment.

The above figures are viewed in Cartesian coordinates. A longitudinal direction X is shown, which can also be referred to as depth X or as length X. A transverse direction Y, which can also be referred to as width Y, extends perpendicular to the longitudinal direction X. A vertical direction Z extends perpendicular to both the longitudinal direction X and the transverse direction Y, which can also be referred to as height Z and which corresponds to the direction of gravity. The longitudinal direction X and the transverse direction Y together form the horizontal X, Y, which can also be referred to as horizontal plane X, Y.

FIG. 1 shows a cross section of a fiber exit element 1, 2, 3 according to the invention according to a first exemplary embodiment. The fiber exit element 1, 2, 3 has a plurality of glass fibers 1, each of which has a core 10 each of which is cylindrically enclosed by a cladding 11 and the cladding 11 is cylindrically enclosed by a coating 12. The cross sections or contours of the cores 10, the claddings 11 and the coatings 12 are each circular. In its longitudinal extension direction, the glass fibers 1 end in the vertical direction Z at a common equal height, each with an open end (not designated). Here, the cores 10 and claddings 11 of the glass fibers 1 extend the same distance and end together at the respective open end. The coatings 12 are each spaced apart in the vertical direction Z at the same height to the open ends of the glass fibers 1.

The fiber exit element 1, 2, 3 further comprises an optical element 2, which can also be referred to as an optical window 2, an optical lens 2, an optical beam splitter 2 or an optical prism 2 or is formed thereof. An optical base body 20 of the optical element 2 in the form of a glass body 20 is, for example according to the first exemplary embodiment of FIG. 1, cuboidal with, for example, edge lengths in the range of 5 mm to 80 mm and has an entry surface 21 pointing downwards in the vertical direction Z and an exit surface 22 pointing upwards on the opposite side. The four sides of the cuboidal optical element 2 are formed by the side surfaces 23. An optical coating 24 in the form of an anti-reflection coating 24 is applied over the entire exit surface 22 of the optical element 2, which can be attributed to the optical element 2.

The open ends of the cores 10 and of the claddings 11 of the glass fibers 1 are arranged with a penetration depth W (not shown) relative to the entry surface 21 of the optical element 2 within the material of the optical element 2. For this purpose, the materials of the cores 10 and of the claddings 11 of the glass fibers 1 have been fused with the material of the optical element 2. This can ensure that signal light beams A, for example in the form of laser light beams A, can be introduced into the optical element 2 as interference-free and as completely as possible. The signal light beams A introduced into the optical element 2 can pass through it and exit to the outside as exit beams A via the exit surface 22 of the optical element 2. This can also improve the mechanical stability of the material bond connection between the glass fibers 1 and the optical element 2.

The fiber exit element 1, 2, 3 further comprises a first housing 30, which may also be referred to as a first enclosure 30. The first housing 30 consists of a first housing shell 30a, which completely surrounds the glass fibers 1 along their longitudinal extension direction, for which purpose the first housing shell 30a can be cylindrical or quadrangular in shape, for example, depending on the design or arrangement of the glass fibers 1. The first housing 30 further comprises a fiber feedthrough element 30b, which may also be referred to as a fiber holder 30b. Accordingly, the fiber feedthrough element 30b is designed, for example, to be circular or quadrangular in shape, corresponding to the design of the first housing shell 30a. The first housing shell 30a and the fiber feedthrough element 30b, together with the optical element 2 or its optical body 20, enclose a first housing space C in which the entry surface 21 of the optical element 2, together with the open ends of the glass fibers 1 connected there, is arranged. The first housing space C may also be referred to as inner housing space C or housing interior space C.

In any case, the glass fibers 1 are received in the region of their coating 12 by corresponding through openings (not designated) of the fiber feedthrough element 30b in the vertical direction Z and are held or fixed there in a materially bonding manner. For its part, the fiber feedthrough element 30b is fixedly connected to the first housing shell 30a, which can also be done in a materially bonding manner. At its end opposite in the vertical direction Z, the first housing shell 30a is fixedly connected to the optical element 2 or its optical body 20, which is also done in a materially bonding manner. By means of the first housing 30, a mechanically defined and stable arrangement or fastening of the glass fibers 1 relative to the optical element 2 or its optical body 20 can thus be achieved, which can facilitate the use, assembly, handling or transport of the fiber exit element 1, 2, 3 or even make it possible in the first place.

At the same time, the design of the first housing 30 can influence the thermal behavior of the optical element 2 or its optical body 20 or reduce its heating by keeping interference beams B away from the optical element 2 or its optical body 20. For this purpose, both the first housing shell 30a and the fiber feedthrough element 30b can be designed to be optically absorbent, which can be achieved, for example, by means of metallic or ceramic materials, which can preferably be designed to be optically matt or black when facing the first housing space C. In this way, interference beams B can be absorbed as completely as possible by the first housing 30 and thus kept away from the optical element 2 or its optical body 20. In order to reduce or minimize the mechanical stress at the connection between the glass fibers 1 and the optical element 2, the housing shell 30a can preferably be made of a material with a coefficient of thermal expansion comparable to that of the glass fibers 1.

Alternatively, the first housing shell 30a can be designed to be completely optically transparent and the fiber feedthrough element 30b can be designed to be completely optically reflective on its inner side 30c facing the first housing space C, so that in this case the interference beams B can exit as completely as possible directly through the first housing shell 30a or possibly also through the optical element 2 to the outside of the first housing 30. This also applies to interference beams B, which initially hit the inner side 30c of the fiber feedthrough element 30b and are deflected from there as completely as possible towards the first housing shell 30a by means of its reflections. This can also prevent or reduce heating of the first housing shell 30a and the fiber feedthrough element 30b. Also, interference beams B can be kept away from the sections of the glass fibers 1 which are arranged outside the first housing 30, since the interference beams B can damage the typically polymeric material of the coatings 12 of the glass fibers 1. It is also possible to combine the variants described above. For the reasons described above, in this case too the housing shell 30a can be designed to be made of a material with a coefficient of thermal expansion similar or corresponding to that of the glass fibers 2.

In any case, interference beams B can be prevented as far as possible from reaching the optical element 2 or its optical body 20 again and contributing to its heating in the form of absorption losses. In addition, for safety reasons, it should usually be ensured in practice that the interference beams B are sufficiently intercepted or dissipated. By selecting the degree of absorption or reflection of the housing shell 30a or the inner side 30c of the fiber feedthrough element 30b, the location of the conversion of the interfering light beams B into heat can be designed accordingly. Thus, the first housing 30 can be designed thermally appropriate for the respective application and the interference beams B can be safely dissipated.

In order to allow the signal light beams A to exit to the outside via the exit surface 22 of the optical element 2 with as little optical loss as possible, an optical coating 24 in the form of an anti-reflection coating 24 for the corresponding wavelength or wavelength range for the signal light beams can be applied to the exit surface 22 of the optical element 2.

FIG. 2 shows a cross section of a fiber exit element 1, 2, 3 according to the invention according to a second exemplary embodiment. In this case, the side of the fiber feedthrough element 30b facing the housing space C, i.e.

its inner side 30c, extends completely at an angle to the glass fibers 1. As a result, the inner side 30c of the fiber feedthrough element 30b is also aligned at an angle to the entry surface 21 of the optical element 2 or its optical body 20, so that interference beams B can be deflected as far as possible towards the first housing shell 30a, in particular if the interference beams B extend substantially parallel or at a very small or acute angle to the glass fibers 1 and thus approximately parallel to the first housing shell 30a according to the first exemplary embodiment of FIG. 1. Signal light beams A, which exit from the glass fiber with a small opening angle (small NA), are relevant in practice for single-mode and large-mode area glass fibers, for example.

FIG. 3 shows a cross section of a fiber exit element 1, 2, 3 according to the invention according to a third exemplary embodiment. In this case, the side of the fiber feedthrough element 30b facing the housing space C, i.e. its inner side 30c, has two sections which extend at an angle to one another and to the glass fibers 1. As a result, the previously described aspects of the oblique deflection of interference beams B can be implemented in such a way that interference beams B can be deflected to both sides in the transverse direction Y. If the fiber exit element 1, 2, 3 is designed to be cylindrical overall, the fiber exit element 30b can be implemented with a conical inner side 30c.

FIG. 4 shows a cross section of a fiber exit element 1, 2, 3 according to the invention according to a fourth exemplary embodiment. In this case, the side of the fiber feedthrough element 30b facing the housing space C, i.e. its inner side 30c, is completely curved towards the glass fibers 1. This may represent an alternative way of implementing the aspects of the invention described above. Allowing the coatings 12 of the glass fibers 1 to terminate within the fiber feedthrough element 30b and thus outside the first housing space C can protect the usually polymeric material of the coatings 12 of the glass fibers 1 from the interference beams B.

FIG. 5 shows a cross section of a fiber exit element 1, 2, 3 according to the invention according to a fifth exemplary embodiment. In this case, on the one hand, the entry surface 21 of the optical element 2 is designed to be completely optically roughened. On the other hand, the first housing shell 30a is designed to be completely optically roughened on the side facing away from the housing space C. This allows the respective exiting interference beams B to be diffusely emitted to the outside, which reduces the intensity of the interference beams B. This can reduce the generation of heat where the diffuse interference beams B hit. In other words, the punctual beam of an interference beam B can be conveyed into a diffusely extended area and thus more efficient cooling can be realized if necessary. Thus, the risk of damage to materials, e.g. the coating 12 of the glass fibers 1, can also be reduced.

FIG. 6 shows a cross section of a fiber exit element 1, 2, 3 according to the invention according to a sixth exemplary embodiment. In this case, the first housing shell 30a is designed to be completely optically roughened on the side facing the first housing space C. As a result, the interference beams B can be emitted diffusely inwards if the inner housing shell 30a is designed to be optically absorbent, or diffusely outwards if the inner housing shell 30a is designed to be optically transparent, which can reduce the intensity of the interference beams B. The exemplary embodiments of FIGS. 5 and 6 can also be implemented in combination.

FIG. 7 shows a cross section of a fiber exit element 1, 2, 3 according to the invention according to a seventh exemplary embodiment. The seventh exemplary embodiment of FIG. 7 is based on the first exemplary embodiment of FIG. 1, wherein the first housing space C is completely filled with material in the form of glass microspheres 28. Thus, the interference beams B can be deflected by the glass microspheres 28 and thereby diffusely distributed, which can reduce the intensity of the interference beams B. The glass microspheres can also rest against the claddings 11 of the glass fibers 1 and act there as cladding light strippers, i.e. absorb interference beams B from the claddings 11 of the glass fibers 1 and thus keep them away from the cores 10 of the glass fibers 1 and the optical element 2.

Alternatively or additionally, it would also be possible to seal or enclose the first housing space C in a fluid-tight manner and to fill it with a fluid in the form of a liquid or a gas, in particular at a predetermined pressure. Depending on the fluid used, this could reduce or minimize the absorption losses within the first housing space C in order to in this way too keep heat away from the optical element 2 as far as possible. The fluid can also fill the spaces between the glass microspheres 28.

FIG. 8 shows a cross section of a fiber exit element 1, 2, 3 according to the invention according to an eighth exemplary embodiment. The eighth exemplary embodiment of FIG. 8 is also based on the first exemplary embodiment of FIG. 1, wherein in this case an intermediate element 29 is arranged transversely in the first housing space C. The intermediate element 29 can be designed to be reflective or absorbent, comparable to the fiber feedthrough element 30b, in order to deflect or absorb the interference beams B as described there. However, the fiber feedthrough element 30b can also be designed as a diffuser to allow the interference beams B to pass through and thereby distribute them in order to attenuate the intensity of the interference beams B.

The intermediate element 29 is arranged parallel to the optical element 2 or its optical body 20 and parallel to the fiber feedthrough element 30b. This takes place in a region of the glass fibers 1 where only the cores 10 with claddings 11 are present, i.e. the coating 12 is not present, so that the coating 12 of the glass fibers 1 can be protected from the interference beams B by the intermediate element 29. The glass fibers 1 or their cores 10 with claddings 11 are guided through through openings (not designated) of the intermediate element 29, as described above with regard to the fiber feedthrough element 30b.

FIG. 9 shows a cross section of a fiber exit element 1, 2, 3 according to the invention according to a ninth exemplary embodiment. In this case, the exemplary embodiments of FIGS. 7 and 8 are combined with one another by separating a sub-region of the first housing space C by means of the intermediate element 29, so that the intermediate element 29 can also be referred to as a separating element 29. This sub-region of the first housing space C is then filled with the glass microspheres 28 and/or with the fluid, as described above with reference to the seventh exemplary embodiment of FIG. 7. Thus, the respective properties and advantages can be combined with one another. At the same time, the costs can be reduced, as only the sub-region of the first housing space C needs to be filled.

FIG. 10 shows a cross section of a fiber exit element 1, 2, 3 according to the invention according to a tenth exemplary embodiment. In this case, the optical element 2 or its optical body 20 has, outside the first housing space C, at least one heat sink 25 in the form of a plurality of cooling fins 25. As a result, the surface area of the side surfaces 23 of the optical element 2 or its optical body 20 can be increased, which can increase or improve the release of heat by means of thermal radiation and convection.

FIG. 11 shows a cross section of a fiber exit element 1, 2, 3 according to the invention according to an eleventh exemplary embodiment. In this case, the optical element 2 or its optical body 20 has, outside the first housing space C, a plurality of through openings 26 for the flow of a fluid. The fluid can, for example, be ambient air, which can flow independently, i.e. without being conveyed, through the through openings 26 and thereby increase or improve the release of heat by means of convection.

FIG. 12 shows a cross section of a fiber exit element 1, 2, 3 according to the invention according to a twelfth exemplary embodiment. In this case, the optical element 2 is designed to be trapezoidal or conical in shape, depending on the design of the fiber exit element 1, 2, 3 in an angular or cylindrical form, so that the exit surface 22 of the optical element 2 is designed to be larger than the entrance surface 21 of the optical element 2. This can increase the area of the exit surface 22 in order to increase or improve the release of heat there by means of thermal radiation and convection.

FIG. 13 shows a cross section of a fiber exit element 1, 2, 3 according to the invention according to a thirteenth exemplary embodiment. In this case, the coatings 12 of the glass fibers 1, which are each formed from a polymer, are each completely enclosed within the first housing space C by a protective element 13, wherein the protective elements 13 are each formed from an at least non-transparent and preferably reflective material. In this way, interference beams B can be specifically kept away from the polymer coatings 12 of the glass fibers 1, which could be damaged by the interference beams B. For this purpose, the protective elements 13 can each comprise a protective cladding 13a, which surrounds the glass fibers 1 or their coatings 12 along the vertical direction Z, preferably cylindrically, and a protective cap 13b, which is arranged on the front side of the coating 12 of the respective glass fiber 1 and is penetrated by the respective core 10 including cladding 11.

FIG. 14 shows a cross section of a fiber exit element 1, 2, 3 according to the invention according to a fourteenth exemplary embodiment, which is based on the first exemplary embodiment of FIG. 1 with the addition that the exit surface 22 facing outwards, i.e. facing away from the first housing space C, has a plurality of microlenses 27, which collectively can also be referred to as microlens array 27. In this case, exactly one microlens 27 is provided per glass fiber 1 and is arranged directly opposite the glass fiber 1, i.e. in the straight-line propagation of the respective signal light beams A. By means of the microlenses 27, the signal light beams A can be influenced upon exit, e.g. for collimation of the signal light beams. The exit surface 22 together with the microlenses 27 is covered by the anti-reflective coating 24.

FIG. 15 shows a cross section of a fiber exit element 1, 2, 3 according to the invention according to a fifteenth exemplary embodiment. In this case, the fiber exit element 1, 2, 3 further comprises a second housing 31 which is connected to the optical element 2 or its optical body 20 and to the first housing 30 and together with the optical element 2 or its optical body 20 and with the first housing 30 forms a second housing space D which completely encloses the optical element 2 and the first housing 30 except for the exit surface 22. The second housing space D may also be referred to as outer housing space D or housing exterior space D. The first housing 30 may thus also be referred to as an inner housing 30 or as an inner enclosure 30 with an inner housing shell 30a. Accordingly, the second housing 31 may be referred to as an outer housing 31 with an outer housing shell 31a. The first, inner housing 30 and the second, outer housing 31 may be collectively referred to as overall housing 3 or as body 3 of the fiber exit element 1, 2, 3. Accordingly, the first housing space C may be referred to as inner housing space C and the second housing space D as outer housing space D.

For this purpose, the second housing 31 has a second housing shell 31a, which extends exactly parallel to the first housing shell 30a and is designed to be completely optically absorbent. The second housing 31 also has an entry-side terminal element 31b, which extends exactly parallel to the fiber feedthrough element 30b and is designed to be completely optically absorbent.

Furthermore, the second housing 31 has an exit-side terminal element 31c, which extends exactly parallel to the optical element 2 or its exit surface 22 and is also designed to be completely optically absorbent. As a result, the interference beams B, which passes through the transparent first housing shell 30a of the first housing 30 to the outside into the second housing space D, can be absorbed as completely as possible by the second housing 31.

Here, the second housing 31, the optical element 2 and the first housing 30 enclose the second housing space D in a fluid-tight manner except for a fluid inlet 31d and a fluid outlet 31e of the inlet-side terminal element 31b, through which a fluid such as a liquid coolant can flow as a fluid flow E through the fluid inlet 31d into the second housing space D and exit the second housing space D again through the fluid outlet 31e. The coolant can be conveyed in the direction of the fluid flow E by means of a fluid conveying device (not shown), such as a pump, and can be supplied to the second, outer housing space D via fluid lines (not shown), such as hoses, and discharged from there. As a result, the dissipation of heat from the second housing space D or, in particular, from the second housing 31 can be increased or improved, so that the heating of the optical element 2 or its optical body 20 can be reduced and the interference beams can be safely dissipated.

In order to additionally release heat to the environment or to the ambient air by means of thermal radiation and convection, the second housing 31 or its second housing shell 31a can have a heat sink 31f in the form of a plurality of cooling fins 31f facing away from the second housing space D.

FIG. 16 shows a cross section of a fiber exit element 1, 2, 3 according to the invention according to a sixteenth exemplary embodiment. In this case, the fiber exit element 1, 2, 3 according to the fifteenth exemplary embodiment of FIG. 15 additionally has the cooling fins 25 of the optical element 2 or its optical body 20, as already explained above with reference to the tenth exemplary embodiment of FIG. 10. This can increase the surface area of the optical element 2 or its optical body 20, which can be reached by the fluid flow E of the coolant, which can further improve heat dissipation via the flowing fluid.

FIG. 17 shows a cross section of a fiber exit element 1, 2, 3 according to the invention according to a seventeenth exemplary embodiment. FIG. 18 shows a horizontal section in a detailed view of the fiber exit element 1, 2, 3 according to the invention according to the seventeenth exemplary embodiment. FIG. 19 shows an alternative to the representation of FIG. 18. In this case, the fiber exit element 1, 2, 3 according to the fifteenth exemplary embodiment of FIG. 15 additionally has the through openings 26 or the flow channels 26 of the optical element 2 or its optical body 20, as already explained above with reference to the eleventh exemplary embodiment of FIG. 11. In this way, the surface area of the optical element 2 or its optical body 20, which can be reached by the fluid flow E of the coolant, can also be increased additionally or alternatively, which can improve heat dissipation via the flowing fluid. The rows of glass fibers 1 can each have a through opening 26 between them, see FIG. 13, or there can only be a single through opening 26 centrally within the horizontal plane X, Y, see FIG. 14. This may depend on the respective application and in particular on the geometric design of the optical element 2 or its optical body 20.

FIG. 20 shows a cross section of a fiber exit element 1, 2, 3 according to the invention according to an eighteenth exemplary embodiment. In this case, the fiber exit element 1, 2, 3 according to the fifteenth exemplary embodiment of FIG. 15 additionally has the trapezoidal or conical optical element 2 or its optical body 20, as already explained above with reference to the twelfth exemplary embodiment of FIG. 12. As a result, the surface area of the optical element 2 or its optical body 20, which can be reached by the fluid flow E of the coolant, can also be increased relative to the second housing space D, which can improve heat dissipation via the flowing fluid.

FIG. 21 shows a cross section of a fiber exit element 1, 2, 3 according to the invention according to a nineteenth exemplary embodiment. In this case, the fiber exit element 1, 2, 3 according to the fifteenth exemplary embodiment of FIG. 15 additionally has the protective elements 13 of the glass fibers 1, as already explained above with reference to the thirteenth exemplary embodiment of FIG. 13. As a result, the corresponding aspects of the invention described there can also be transferred to the fiber exit element 1, 2, 3 according to the invention according to the nineteenth exemplary embodiment.

FIG. 22 shows a cross section of a fiber exit element 1, 2, 3 according to the invention according to a twentieth exemplary embodiment. In this case, the fiber exit element 1, 2, 3 according to the fifteenth exemplary embodiment of FIG. 15 additionally has the microlenses 27 of the exit surface 22 of the optical element 2, as already explained above with reference to the fourteenth exemplary embodiment of FIG. 14. As a result, the corresponding aspects of the invention described there can also be transferred to the fiber exit element 1, 2, 3 according to the invention according to the twentieth exemplary embodiment.

The features of the sixth to ninth exemplary embodiments of FIGS. 6 to 9 can also be transferred in particular to the fiber exit element 1, 2, 3 according to the fifteenth exemplary embodiment of FIG. 15.

### LIST OF REFERENCE SIGNS (PART OF THE DESCRIPTION)

A signal light beams; laser light beams; emission beams
B interference beams
C first, inner housing space; housing interior space
D second, outer housing space; housing exterior space
E fluid flow
X longitudinal direction; depth; length
Y transverse direction; width
Z vertical direction; height
X, Y horizontal, horizontal plane
1, 2, 3 fiber exit element; signal light beam output; fiber exit optics; fiber array
1 glass fibers
10 cores of the glass fibers 1
11 claddings of the glass fibers 1
12 coating of the glass fibers 1
13 protective elements of the glass fibers 1
13a protective cladding of the protective elements 13
13b protective caps of the protective elements 13
2 optical element; optical window; optical lens, optical beam splitter; optical prism
20 optical body; glass body
21 entry surface of the optical element 2 or the optical body 20
22 exit surface of the optical element 2 or the optical body 20
23 side surfaces of the optical element 2 or the optical body 20
24 optical coating or anti-reflection coating of exit surface 22
25 heat sink or cooling fins of the optical element 2 or the optical body 20
26 through openings or flow channels of the optical element 2 or the optical body 20
27 microlenses; microlens array
28 loose glass bodies; glass microspheres; quartz glass spheres
29 intermediate element; separating element
3 overall housing; body
30 first, inner housing; first, inner enclosure
30a first inner housing shell of the first inner housing 30
30b fiber feedthrough element or fiber holder of the first, inner housing 30
30c inner side of the fiber feedthrough element 30b of the first inner housing 30
31 second, outer housing; second, outer enclosure
31a second outer housing shell of the second outer housing 31
31b entry-side terminal element of the second, outer housing 31
31c exit-side terminal element of the second, outer housing 31
31d fluid inlet of the second, outer housing 31
31e fluid outlet of the second, outer housing 31
31f heat sink or cooling fins of the second, outer housing 31

1. A fiber exit element
having a plurality of glass fibers each having at least one core, each of which is designed to guide a signal light beam, and
having at least one optical element, an optical lens, an optical beam splitter or an optical prism, which is connected at an entry surface to an open end of each of the cores of the glass fibers, preferably further to an open end of a cladding of the glass fibers substantially enclosing the core, and is designed to receive the signal light beam from the open ends of the cores of the glass fibers and to emit same outwards in the form of exit beams via at least one exit surface,
characterized by
at least one first housing which is connected to the optical element and, together with the optical element, forms a first housing space which at least substantially encloses at least the entry surface of the optical element with the open ends of the cores of the glass fibers,
wherein the first housing has a first housing shell which extends at least substantially, parallel to the glass fibers and is designed to be optically transparent and/or optically absorbent at least in sections, and
wherein the first housing has a fiber feedthrough element through which the glass fiber extends, preferably vertically, in a loosely guided or fixedly connected manner, and at least sections of which are designed to be optically reflective and/or optically absorbent,
wherein preferably the first housing shell and/or the fiber feedthrough element comprises/comprise a material with a comparatively low thermal expansion, and preferably consists/consist thereof.

2. The fiber exit element according to claim 1,
wherein the first housing shell is completely optically transparent and the fiber feedthrough element is completely optically reflective.

3. The fiber exit element according to claim 1,
wherein the side of the fiber feedthrough element facing the housing space extends at least in sections, preferably completely, at an angle to the glass fibers.

4. The fiber exit element according to claim 1,
wherein the side of the fiber feedthrough element facing the housing space has at least two sections which extend at an angle to one another and/or to the glass fibers.

5. The fiber exit element according to claim 1,
wherein the side of the fiber feedthrough element facing the housing space extends at least in sections, preferably completely, curved towards the glass fibers.

6. The fiber exit element according to claim 1,
wherein the first housing shell is designed to be optically roughened at least in sections, preferably completely, on the side facing the housing space and/or on the side facing away from the housing space.

7. The fiber exit element according to claim 1,
wherein at least the entry surface of the optical element, preferably all outer surfaces of the optical element except the exit surface of the optical element, are designed to be optically roughened, and
wherein preferably at least the exit surface of the optical element, preferably precisely the exit surface of the optical element, is designed with an optically smooth surface quality.

8. The fiber exit element according to claim 1,
wherein the exit surface of the optical element has, at least in sections, preferably over the entire surface, an optical coating, preferably an optical anti-reflection coating, and/or a plurality of microlenses, preferably one microlens per glass fiber and directly opposite the glass fiber.

9. The fiber exit element according to claim 1,
wherein the first housing and the optical element enclose the first housing space in a fluid-tight manner,
wherein the first housing space is filled with fluid.

10. The fiber exit element according to claim 1,
wherein the first housing space is at least in sections filled with material, preferably filled with a plurality of loose glass bodies.

11. The fiber exit element according to claim 1,
further having at least one intermediate element which is arranged between the optical element and the fiber feedthrough element, preferably parallel to the fiber feedthrough element,
wherein the glass fibers extend, preferably vertically, in a loosely guided or fixedly connected manner, through the intermediate element, and
wherein the intermediate element is at least in sections designed to be optically reflective, optically absorbent and/or designed as an optical diffuser,
wherein preferably the intermediate element comprises a material with a comparatively low thermal expansion, preferably consisting thereof.

12. The fiber exit element according to claim 11,
wherein the first housing shell in sections, the optical element and the intermediate element together enclose a sub-region of the first housing space in a fluid-tight manner,
wherein the sub-region of the first housing space is filled with fluid.

13. The fiber exit element according to claim 11,
wherein the first housing shell in sections, the optical element and the intermediate element together enclose a sub-region of the first housing space,
wherein the sub-region of the first housing space is at least in sections filled with material, preferably filled with a plurality of loose glass bodies.

14. The fiber exit element according to claim 1,
further having at least one second housing which is connected to the optical element and/or to the first housing and together with the optical element and the first housing forms a second housing space which encloses the optical element and the first housing at least substantially, preferably completely, except for the exit surface,
wherein the second housing comprises a second housing shell which extends at least substantially, preferably exactly, parallel to the first housing shell and is designed to be at least in sections, preferably completely, optically absorbent,
wherein the second housing comprises an entry-side terminal element which extends at least substantially, preferably exactly, parallel to the fiber feedthrough element and is designed to be at least in sections, preferably completely, optically absorbent, and/or
wherein the second housing comprises an exit-side terminal element which extends at least substantially, preferably exactly, parallel to the optical element, preferably to the exit surface thereof, and is designed to be at least in sections, preferably completely, optically absorbent.

15. The fiber exit element according to claim 14,
wherein the second housing, the optical element and the first housing enclose the second housing space in a fluid-tight manner, and
wherein the second housing, preferably the inlet-side terminal element of the second housing, has a fluid inlet and a fluid outlet, so that a fluid can flow through the fluid inlet into the second housing space and exit the second housing space again through the fluid outlet.

16. The fiber exit element according to claim 14,
wherein the second housing, preferably the second housing shell, has at least one heat sink, preferably a plurality of cooling fins, facing away from the second housing space and/or protruding into the second housing space.

17. The fiber exit element according to claim 1,
wherein, outside the first housing space, the optical element comprises preferably a heat sink, and inside the second housing space the optical element comprises at least one heat sink, preferably a plurality of cooling fins.

18. The fiber exit element according to claim 1,
wherein the optical element outside the first housing space has preferably and within the second housing space has a plurality of through openings for the flow of a fluid and/or a plurality of through openings which are at least in sections, preferably completely, filled with a material having a comparatively good thermal conductivity.

19. The fiber exit element according to claim 1,
wherein the exit surface of the optical element is designed to be larger than the entry surface of the optical element,
wherein the optical element is preferably designed to be trapezoidal or conical in shape.

20. The fiber exit element according to claim 1,
wherein at least one glass fiber, preferably a plurality of glass fibers, particularly preferably all glass fibers, has/have a coating, preferably of a polymer, which is arranged in sections in the first housing space,
wherein the coating, at least within the first housing space, is enclosed at least in sections, preferably completely, by a non-transparent, preferably reflective and/or temperature-resistant material.
